(19) United States
(12) Patent Application Publication
(10) Pub. No.: US 2026/0031039 A1
(43) Pub. Date: Jan. 29, 2026

(54) DISPLAY DEVICE AND ELECTRONIC DEVICE INCLUDING THE DISPLAY DEVICE

(71) Applicant: SAMSUNG DISPLAY CO., LTD., YONGIN-SI (KR)

(72) Inventors: JAEKEUN LIM, Yongin-si (KR); BON-SEOG GU, Yongin-si (KR); JINYOUNG ROH, Yongin-si (KR); HAE-KWAN SEO, Yongin-si (KR)

(21) Appl. No.: 19/262,436

(22) Filed: Jul. 8, 2025

(30) Foreign Application Priority Data
Jul. 24, 2024 (KR) 10-2024-0097836

(51) Int. Cl. G09G 3/3233; G09G 3/32

(52) U.S. Cl. CPC G09G 3/3233; G09G 3/32; G09G 2300/043; G09G 2300/0819; G09G 2310/08; G09G 2330/021

(57) ABSTRACT

A display device includes a first pixel including a first pixel circuit and a first light emitting element, a second pixel including a second pixel circuit and a second light emitting element, and a data line. The first pixel circuit includes a 1-1st transistor, a 2-1st transistor, and a 3-1st transistor. The 3-1st transistor includes a 1-1st sub-transistor receiving a second scan signal, and a 1-2nd sub-transistor receiving the first scan signal. The second pixel circuit includes a 1-2nd transistor, a 2-2nd transistor, and a 3-2nd transistor. The 3-2nd transistor includes a 2-1st sub-transistor receiving the first scan signal, and a 2-2nd sub-transistor receiving the second scan signal that is delayed by a predetermined time.

### CROSS-REFERENCE TO RELATED APPLICATIONS

This U.S. patent application claims priority under 35 U.S.C. § 119 to Korean Patent Application No. 10-2024-0097836 filed on Jul. 24, 2024, in the Korean Intellectual Property Office, the disclosure of which is incorporated by reference in its entirety herein.

### 1. Technical Field

Embodiments of the present disclosure described herein are directed to a display device and an electronic device including the display device with reduced power consumption.

### 2. Discussion of Related Art

Display devices are increasingly utilized across a range of multimedia devices, including televisions, mobile phones, a tablet personal computer (PC), navigation systems, and a game consoles. Examples of these display devices include an Organic Light Emitting diode display (OLED) display device, a Liquid Crystal Display (LCD) device and a MicroLED Display device. OLED displays are known for their superior contrast, color accuracy, and flexibility, making them ideal for high-quality visual experiences in varied device formats. LCDs offer cost-effectiveness and high brightness levels, suited for broad consumer use, including outdoor environments. MicroLED technology provides exceptional brightness and energy efficiency, along with a long lifespan, making it suitable for both small-scale and large-scale advanced display applications.

In OLED display devices, a demultiplexer (demux) circuit is typically used to route data signals to the appropriate pixels, enabling efficient signal distribution while reducing the number of required data lines. However, the inclusion of a demux circuit comes with the drawback of additional power consumption, as it requires continuous power to operate and switch signals correctly. This added power demand becomes increasingly significant in high-resolution and low-power applications, such as mobile and wearable devices. Therefore, there is a need for a display device that eliminates the demux circuit, thereby reducing power consumption while maintaining efficient pixel data distribution.

### SUMMARY

Embodiments of the present disclosure provide a display device and an electronic device including the display device with reduced power consumption.

According to an embodiment, a display device includes a first pixel including a first pixel circuit and a first light emitting element, a second pixel including a second pixel circuit and a second light emitting element, and a data line configured to receive a data signal. The first pixel circuit includes a 1-1st transistor including a gate electrode connected to a 1-1st node and connected between a first power source line receiving a first power voltage, and a 2-1st node, a 2-1st transistor connected to the data line and receiving a first scan signal, and a 3-1st transistor connected between the 1-1st node and the 2-1st node. The 3-1st transistor includes a 1-1st sub-transistor receiving a second scan signal, and a 1-2nd sub-transistor receiving the first scan signal. The second pixel circuit includes a 1-2nd transistor including a gate electrode connected to a 1-2nd node and connected between a 2-2nd node and the first power source line, a 2-2nd transistor receiving the first scan signal and connected to the data line, and a 3-2nd transistor connected between the 1-2nd node and the 2-2nd node. The 3-2nd transistor includes a 2-1st sub-transistor receiving the first scan signal, and a 2-2nd sub-transistor receiving the second scan signal that is delayed by a predetermined time.

The 1-1st sub-transistor may be connected between the 1-1st node and the 1-2nd sub-transistor. The 1-2nd sub-transistor may be connected between the 2-1st node and the 1-1st sub-transistor.

The 2-1st sub-transistor may be connected between the 1-2nd node and the 2-2nd sub-transistor. The 2-2nd sub-transistor may be connected between the 2-2nd node and the 2-1st sub-transistor.

The 2-1st sub-transistor may be connected between the 2-2nd node and the 2-2nd sub-transistor. The 2-2nd sub-transistor may be connected between the 1-2nd node and the 2-1st sub-transistor.

The 1-1st sub-transistor may be connected between the 2-1st node and the 1-2nd sub-transistor. The 1-2nd sub-transistor may be connected between the 1-1st node and the 1-1st sub-transistor.

The 2-1st sub-transistor may be connected between the 1-2nd node and the 2-2nd sub-transistor. The 2-2nd sub-transistor may be connected between the 2-2nd node and the 2-1st sub-transistor.

The 2-1st sub-transistor may be connected between the 2-2nd node and the 2-2nd sub-transistor. The 2-2nd sub-transistor may be connected between the 1-2nd node and the 2-1st sub-transistor.

The first pixel circuit may further include a first capacitor connected between the first power source line and the 1-1st node.

The first light emitting element may be connected between the 2-1st node and a second power source line receiving a second power voltage having a different voltage level from a voltage level of the first power voltage.

The second light emitting element may be connected between the 2-2nd node and the second power source line.

When viewed from above a plane, the first light emitting element may overlap the first pixel circuit, and the second light emitting element may be positioned in a region offset from the second pixel circuit.

The first light emitting element and the second light emitting element may emit light of the same color.

The display device may further include a first extension wire connected between the first light emitting element and the first pixel circuit, and a second extension wire connected between the second light emitting element and the second pixel circuit. A length of the first extension wire may be shorter than a length of the second extension wire.

The first pixel circuit may further include a 4-1st transistor receiving a third scan signal and connected between the 1-1st node and a first voltage line receiving a first initialization voltage, a 5-1st transistor receiving an emission control signal and connected between the first power source line and the 1-1st transistor, a 6-1st transistor receiving the emission control signal and connected between the first light emitting element and the 1-1st transistor, and a 7-1st transistor receiving the first scan signal is provided and connected between the first light emitting element and a second voltage line receiving a second initialization voltage.

The first scan signal may be a signal obtained by delaying the third scan signal by a predetermined time.

During a first data write period, the first scan signal and the second scan signal may be activated to turn om the 3-1st transistor. During the first data write period, the 1-1st node may at a voltage value obtained by subtracting a threshold voltage of the 1-1st transistor from a first voltage of the data signal.

During a second data write period different from the first data write period, the first scan signal and the second scan signal delayed by the predetermined time may be activated to turn on the 3-2nd transistor. During the second data write period, the 1-2nd node may at a voltage value obtained by subtracting a threshold voltage of the 1-2nd transistor from a second voltage of the data signal.

A part of an activation period of the first scan signal may overlap an activation period of the second scan signal. The other parts of the activation period of the first scan signal may overlap the activation period of the second scan signal, which is delayed by the predetermined time.

Voltage levels of the first voltage and the second voltage may be different from each other.

Voltage levels of the first voltage and the second voltage may be the same as each other.

According to an embodiment, a display device includes a first pixel, a second pixel, and a data line connected to the first pixel and the second pixel. The first pixel includes a first pixel circuit and a first light emitting element connected to the first pixel circuit. The first pixel circuit includes a 1-1st transistor including a gate electrode connected to a 1-1st node, a first electrode connected to a first power source line receiving a first power voltage, and a second electrode connected to a 2-1st node, a 2-1st transistor including a gate electrode receiving a first scan signal, a first electrode connected to the data line, and a second electrode, and a 3-1st transistor connected between the 1-1st node and the 2-1st node. The 3-1st transistor includes a 1-1st sub-transistor including a gate electrode receiving a second scan signal, and a 1-2nd sub-transistor including a gate electrode receiving the first scan signal. The second pixel includes a second pixel circuit and a second light emitting element connected to the second pixel circuit. The second pixel circuit includes a 1-2nd transistor including a gate electrode connected to a 1-2nd node, a first electrode electrically connected to the first power source line, and a second electrode connected to a 2-2nd node, a 2-2nd transistor including a gate electrode receiving the first scan signal, a first electrode connected to the data line, and a second electrode, and a 3-2nd transistor connected between the 1-2nd node and the 2-2nd node. The 3-2nd transistor includes a 2-1st sub-transistor including a gate electrode receiving the first scan signal, and a 2-2nd sub-transistor including a gate electrode receiving the second scan signal that is delayed by a predetermined time.

The 1-1st sub-transistor may be connected between the 1-1st node and the 1-2nd sub-transistor. The 1-2nd sub-transistor may be connected between the 2-1st node and the 1-1st sub-transistor.

The 2-1st sub-transistor may be connected between the 1-2nd node and the 2-2nd sub-transistor. The 2-2nd sub-transistor may be connected between the 2-2nd node and the 2-1st sub-transistor.

The 2-1st sub-transistor may be connected between the 2-2nd node and the 2-2nd sub-transistor. The 2-2nd sub-transistor may be connected between the 1-2nd node and the 2-1st sub-transistor.

The 1-1st sub-transistor may be connected between the 2-1st node and the 1-2nd sub-transistor. The 1-2nd sub-transistor may be connected between the 1-1st node and the 1-1st sub-transistor.

The 2-1st sub-transistor may be connected between the 1-2nd node and the 2-2nd sub-transistor. The 2-2nd sub-transistor may be connected between the 2-2nd node and the 2-1st sub-transistor.

The 2-1st sub-transistor may be connected between the 2-2nd node and the 2-2nd sub-transistor. The 2-2nd sub-transistor may be connected between the 1-2nd node and the 2-1st sub-transistor.

When viewed from above a plane, the first light emitting element may overlap the first pixel circuit, and the second light emitting element may be positioned in a region offset from the second pixel circuit. The first light emitting element and the second light emitting element may emit light of the same color.

The display device may further include a first extension wire connected between the first light emitting element and the first pixel circuit, and a second extension wire connected between the second light emitting element and the second pixel circuit. A length of the first extension wire may be shorter than a length of the second extension wire.

During a first data write period, the first scan signal and the second scan signal may be activated to turn on the 3-1st transistor. During the first data write period, the 1-1st node may at a voltage value obtained by subtracting a threshold voltage of the 1-1st transistor from a first voltage of a data signal received through the data line. During a second data write period provided after the first data write period, the first scan signal and the second scan signal delayed by the predetermined time may be activated to turn on the 3-2nd transistor. During the second data write period, the 1-2nd node may be at a voltage value obtained by subtracting a threshold voltage of the 1-2nd transistor from a second voltage of the data signal.

According to an embodiment, an electronic device includes a display panel. The display panel includes first and second pixels and a scan driver. The first pixel includes a first pixel circuit and a first light-emitting element. The second pixel includes a second pixel circuit and a second light-emitting element. The scan driver is configured to provide a first scan signal and a second scan signal. The first pixel circuit includes a first driving transistor including a gate electrode connected to a first node and connected between a first power source line and a second node; a first switch transistor connected to a data line and configured to receive the first scan signal; and a first charge transfer transistor connected between the first node and the second node and configured to receive the first scan signal and the second scan signal. The second pixel circuit includes a second driving transistor including a gate electrode connected to a third node and connected between a fourth node and the first power source line; a second switch transistor connected to the data line and configured to receive the first scan signal; and a second charge transfer transistor connected between the third node and the fourth node and configured to receive the first scan signal and the second scan signal that is delayed by a predetermined time.

### BRIEF DESCRIPTION OF THE FIGURES

The above and other objects and features of the present disclosure will become apparent by describing in detail embodiments thereof with reference to the accompanying drawings.

FIG. 1 is a perspective view of a display device, according to an embodiment of the present disclosure.

FIG. 2 is a block diagram of a display device, according to an embodiment of the present disclosure.

FIG. 3A illustrates a partial configuration of a display panel, according to an embodiment of the present disclosure.

FIG. 3B is a timing diagram of data signals, according to an embodiment of the present disclosure.

FIG. 4A illustrates a partial configuration of a display panel, according to an embodiment of the present disclosure.

FIG. 4B is a timing diagram of data signals, according to an embodiment of the present disclosure.

FIG. 5 is an equivalent circuit diagram illustrating pixels, according to an embodiment of the present disclosure.

FIG. 6A is an equivalent circuit diagram illustrating pixels, according to an embodiment of the present disclosure.

FIG. 6B is an equivalent circuit diagram illustrating pixels, according to an embodiment of the present disclosure.

FIG. 6C is an equivalent circuit diagram illustrating pixels, according to an embodiment of the present disclosure.

FIG. 7 is a timing diagram for describing an operation of a display device, according to an embodiment of the present disclosure.

FIGS. 8A to 8D are diagrams for describing an operation of a pixel, according to an embodiment of the present disclosure.

FIG. 9 illustrates an electronic device according to an embodiment of the present disclosure. In some embodiments, electronic device 1002 includes display device 1000 as described in the present disclosure

### DETAILED DESCRIPTION

In the specification, the expression that a first component (or region, layer, part, portion, etc.) is “on”, “connected with”, or “coupled with” a second component means that the first component is directly on, connected with, or coupled with the second component or means that a third component is interposed therebetween.

The same reference numerals refer to the same components. The term “and/or” includes one or more combinations in each of which associated elements are defined.

Although the terms “first”, “second”, etc. may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The articles “a,” “an,” and “the” are singular in that they have a single referent, but the use of the singular form in the specification should not preclude the presence of more than one referent.

Also, terms such as “under”, “below”, “on”, “above”, etc. are used to describe the spatial relationships between components illustrated in the drawings. These relative terms maybe be interpreted according to the directional orientation presented in the drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

Hereinafter, embodiments of the present disclosure will be described with reference to accompanying drawings.

At least one embodiment relates to a display device with an optimized pixel circuit design that reduces power consumption. The device includes at least two pixels, each including a respective pixel circuit and a light-emitting element. A charge transfer transistor of each pixel circuit is configured as dual transistors, each having two sub-transistors that receive different scan signals. The first pixel's charge transfer transistor includes a first sub-transistor controlled by a second scan signal and a second sub-transistor controlled by a first scan signal. The second pixel's charge transfer transistor follows a similar structure but introduces a delay in the second scan signal applied to its second sub-transistor. This staggered scan signal approach allows adjacent pixels to share a data line efficiently, effectively internalizing the demultiplexer function within the pixel circuit itself. As a result, the need for a separate demux circuit is eliminated, reducing power consumption and circuit complexity while maintaining efficient pixel control and data distribution.

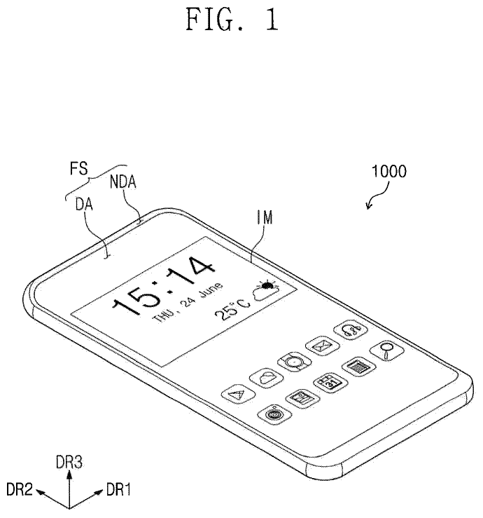

FIG. 1 is a perspective view of a display device, according to an embodiment of the present disclosure.

Referring to FIG. 1, a display device 1000 may be a device activated depending on an electrical signal. The display device 1000 may be implemented in various forms, including but not limited to tablets, laptops, computers, smart televisions, virtual reality (VR) devices and smartphones. These examples are provided for illustrative purposes only and do not limit the scope of the disclosure. It is evident that the described technology can be applied to other types of display devices without deviating from the principles of the present disclosure.

The display device 1000 may display an image IM on a display surface FS, which is parallel to each of a first direction DR1 and a second direction DR2, in a third direction DR3 crossing the first direction DR1 and the second direction DR2. The display surface FS on which the image IM is displayed may correspond to a front surface of the display device 1000.

The display surface FS of the display device 1000 may be divided into a plurality of areas. A display area DA and a non-display area NDA may be defined in the display surface FS of the display device 1000.

The display area DA may be an area where the image IM is displayed, and a user may visually perceive the image IM through the display area DA. A shape of the display area DA may be defined substantially by the non-display area NDA. However, this is illustrated as an example. The non-display area NDA may be positioned to be adjacent to only one side of the display area DA or may be omitted. However, the embodiments are not limited thereto. For example, the display device 1000 maybe implemented in various forms.

The non-display area NDA may be an area adjacent to the display area DA, and may be an area in which the image IM is not displayed. The bezel area of the display device 1000 may be defined by the non-display area NDA.

The non-display area NDA may surround the display area DA. However, the embodiments are not limited thereto. For example, the non-display area NDA may be adjacent to only a portion of the edge of the display area DA.

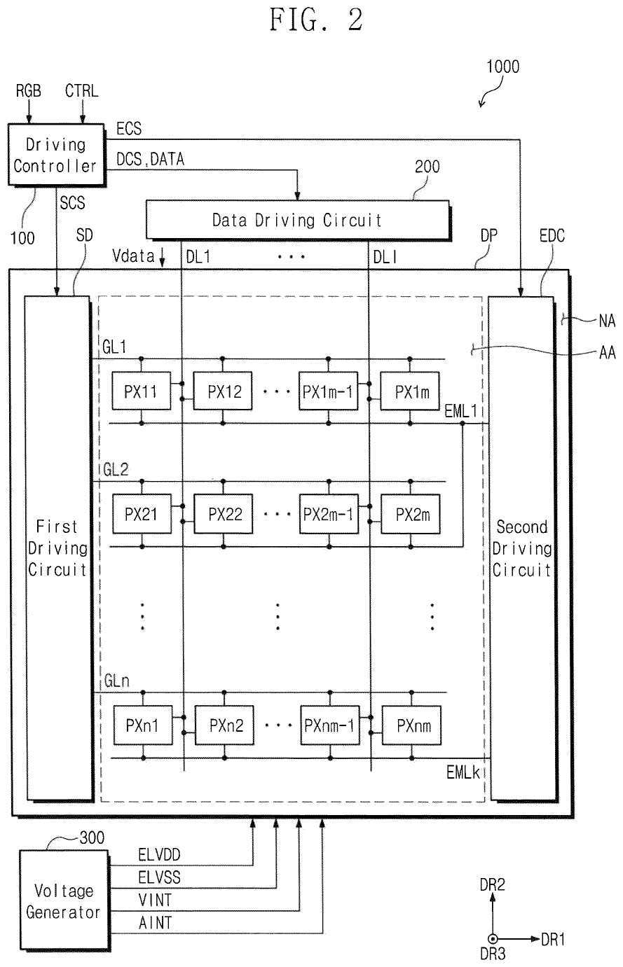

FIG. 2 is a block diagram of a display device, according to an embodiment of the present disclosure.

Referring to FIG. 2, the display device 1000 may include a display panel DP, a driving controller 100, a data driving circuit 200, and a voltage generator 300.

The display panel DP according to an embodiment of the present disclosure may be a light emitting display panel, but is not limited thereto. For example, the display panel DP may be an organic light emitting display panel, a quantum dot light emitting display panel, a micro-LED display panel, or a nano-LED display panel. A light emitting layer of the organic light emitting display panel may include an organic luminescent material. A light emitting layer of the quantum dot light emitting display panel may include a quantum dot or a quantum rod. A light emitting layer of the micro-LED display panel may include a micro-LED. A light emitting layer of the nano-LED display panel may include a nano-LED.

The driving controller 100 may receive an image signal RGB and a control signal CTRL. The driving controller 100 may generate an image data signal DATA by converting a data format of the image signal RGB so as to be suitable for the interface specification of the data driving circuit 200. The driving controller 100 may output a scan control signal SCS, a data control signal DCS, and an emission driving control signal ECS.

The data driving circuit 200 may receive the data control signal DCS and the image data signal DATA from the driving controller 100. The data driving circuit 200 may convert the image data signal DATA into data signals Vdata and may output the data signals Vdata to a plurality of data lines DL1 to DLl, respectively where ‘l’ may be a natural number of 2 or more. The data signals Vdata may be analog voltages corresponding to grayscale values of the image data signal DATA.

In an embodiment of the present disclosure, during a period of a single frame (e.g., a frame period), the data driving circuit 200 may output the data signals Vdata corresponding to the image data signal DATA to the data lines DL1 to DLl, respectively.

The voltage generator 300 may generate voltages used to operate the display panel DP. In an embodiment of the present disclosure, the voltage generator 300 may generate a first power source ELVDD (e.g., a first power voltage), a second power source ELVSS (e.g., a second power voltage), a first initialization voltage VINT, and a second initialization voltage AINT. The first power source ELVDD may have a higher voltage level than the second power source ELVSS.

An active area AA and a peripheral area NA adjacent to the active area AA may be defined in the display panel DP. When viewed from above a plane or from a top-down perspective, the active area AA overlaps the display area DA (see FIG. 1) of the display device 1000, and the peripheral area NA may overlap the non-display area NDA (see FIG. 1).

The display panel DP may include scan lines GL1 to GLn, emission control lines EML1 to EMLk, the data lines DL1 to DLl, and a plurality of pixels PX11 to PXnm to PXnm. The scan lines GL1 to GLn, the emission control lines EML1 to EMLk, the data lines DL1 to DLl, and the plurality of pixels PX11 to PXnm11 to PXnm may be positioned in the active area AA.

FIG. 2 illustrates 12 pixels PX11 to PXnm, PX12, PX1m-1, PX1m, PX21, PX22, PX2m-1, PX2m, PXn1, PXn2, PXnm-1, and PXnm. Each of ‘n’, ‘m’, and ‘k’ may be natural numbers greater than or equal to 2.

The display panel DP may further include a first driving circuit SD and a second driving circuit EDC. The first driving circuit SD and the second driving circuit EDC may be placed in the peripheral area NA.

The first driving circuit SD may be arranged on a first side of the display panel DP. The plurality of scan lines GL1 to GLn may extend from the first driving circuit SD in the first direction DR1. The plurality of scan lines GL1 to GLn may be provided to a plurality of pixel rows, respectively. In this case, the first driving circuit SD may be referred to as “performing first-stage driving”.

The second driving circuit EDC may be arranged on a second side of the display panel DP. The emission control lines EML1 to EMLk may extend from the second driving circuit EDC in a direction opposite to the first direction DR1. The plurality of emission control lines EML1 to EMLk may be provided, one per two pixel rows. That is, ‘n’ may be twice ‘k’. In this case, the second driving circuit EDC may be referred to as “performing second-stage driving”. For example, each emission control line EML1 to EMLk may be assigned to every two pixel rows. However, this is merely an example. A configuration of the emission control lines EML1 to EMLk according to an embodiment of the present disclosure is not limited thereto. For example, when ‘n’ is equal to ‘k’, the plurality of emission control lines EML1 to EMLk may be provided for a plurality of pixel rows, respectively, and the second driving circuit EDC may be referred to as “performing first-stage driving”.

The scan lines GL1 to GLn and the emission control lines EML1 to EMLk may be arranged spaced apart from each other in the second direction DR2.

The data lines DL1 to DLl may extend from the data driving circuit 200 in a direction opposite to the second direction DR2. Each of the data lines DL1 to DLl may be arranged spaced from each other in the first direction DR1.

In the example shown in FIG. 2, the first driving circuit SD and the second driving circuit EDC are arranged to face each other with the pixels PX11 to PXnm interposed therebetween, but the present disclosure is not limited thereto. For example, the first driving circuit SD and the second driving circuit EDC may be positioned adjacent to each other on one of the first side and the second side of the display panel DP. In an embodiment, the first driving circuit SD and the second driving circuit EDC are implemented with a single circuit.

The plurality of pixels PX11 to PXnm may be electrically connected to the scan lines GL1 to GLn, the emission control lines EML1 to EMLk, and the data lines DL1 to DLl.

Among the plurality of pixels PX11 to PXnm, two pixels adjacent to each other in the first direction DR1 may be connected to a single data line. For example, the adjacent pixels PX11 and PX12 may be electrically connected to the one data line DL1, and other adjacent pixels PX1m-1 and PX1m may be electrically connected to the one other data line DLl.

In this case, the number of IC chips including the data driving circuit 200 included in the display device 1000 may be reduced as the number of channels is reduced. Moreover, as the number of channels of a single IC chip including the data driving circuit 200 is reduced, the cost of the IC chip may be reduced, and the area size of the peripheral area NA may be reduced.

Furthermore, according to an embodiment of the present disclosure, the pixel area size may be reduced compared to a case where two adjacent pixels are respectively connected to data lines. The number of pixels positioned in the same area size may be increased. Accordingly, the display device 1000 is capable of high-resolution implementations.

Each of the plurality of pixels PX11 to PXnm may include a pixel circuit and a light emitting element electrically connected to the pixel circuit. Light emitting elements of the plurality of pixels PX11 to PXnm may generate different colors of light. For example, the plurality of pixels PX11 to PXnm may include red pixels generating red color light, green pixels generating green color light, and blue pixels generating blue color light. A light emitting element of a red pixel, a light emitting element of a green pixel, and a light emitting element of a blue pixel may include light emitting layers of different materials.

The pixel circuit may include at least one transistor and at least one capacitor. The first driving circuit SD and the second driving circuit EDC may include transistors formed through the same process as transistors of the pixel circuit.

Each of the plurality of pixels PX11 to PXnm may receive the first power source ELVDD, the second power source ELVSS, the first initialization voltage VINT, and the second initialization voltage AINT from the voltage generator 300.

The first driving circuit SD may receive the scan control signal SCS from the driving controller 100. The first driving circuit SD may output scan signals to the scan lines GL1 to GLn in response to the scan control signal SCS.

The second driving circuit EDC may output emission signals to emission control lines EML1 to EMLk in response to the emission driving control signal ECS from the driving controller 100.

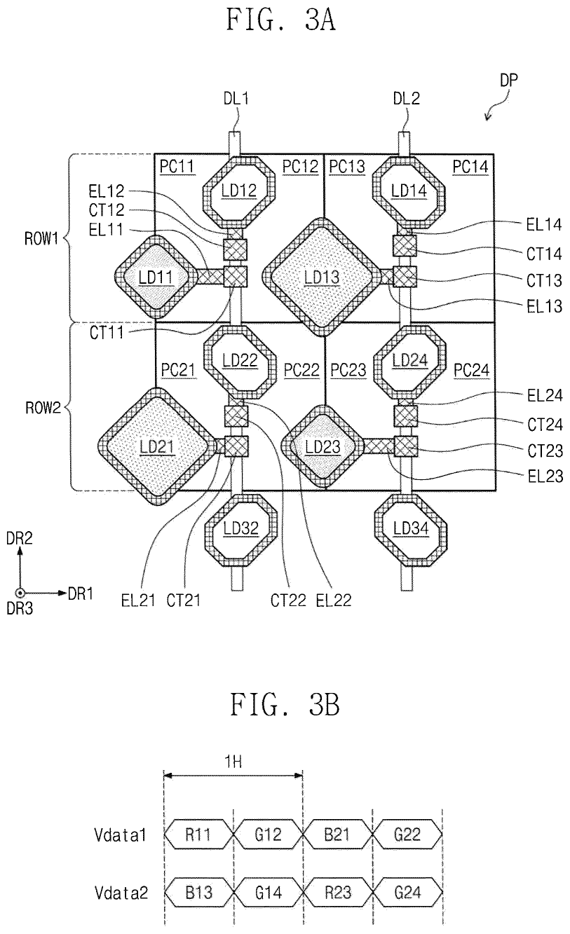

FIG. 3A illustrates a partial configuration of a display panel, according to an embodiment of the present disclosure. FIG. 3B is a timing diagram of data signals, according to an embodiment of the present disclosure.

Referring to FIGS. 2 to 3B, the display panel DP may include the plurality of data lines DL1 and DL2, a plurality of pixel circuits PC11 to PC14 and PC21 to PC24, and a plurality of light emitting elements LD11, LD12, LD13, LD14, LD21, LD22, LD23, LD24, LD32, and LD34.

The plurality of pixel circuits PC11 to PC14 and PC21 to PC24 and the plurality of light emitting elements LD11, LD12, LD13, LD14, LD21, LD22, LD23, LD24, LD32, and LD34 corresponding thereto may be included in the plurality of pixels PX11 to PXnm.

Among the plurality of pixel circuits PC11 to PC14 and PC21 to PC24, some pixel circuits PC11 to PC14 may be positioned in a first pixel row ROW1 and may be sequentially placed in the first direction DR1.

Among the plurality of pixel circuits PC11 to PC14 and PC21 to PC24, the remaining pixel circuits PC21 to PC24 may be positioned in a second pixel row ROW2 and may be sequentially arranged in the first direction DR1. The second pixel row ROW2 may be spaced apart from the first pixel row ROW1 in the second direction DR2.

Each of the plurality of data lines DL1 and DL2 may extend in the second direction DR2. The plurality of data lines DL1 and DL2 may be placed spaced apart from each other in the first direction DR1. The plurality of data lines DL1 and DL2 may include the first data line DL1 and the second data line DL2.

Among the plurality of pixel circuits PC11 to PC14 and PC21 to PC24, two pixels adjacent to each other in the first direction DR1 may be electrically connected to one data line.

The first data line DL1 may be electrically connected to some pixel circuits PC11, PC12, PC21, and PC22 among the plurality of pixel circuits PC11 to PC14 and PC21 to PC24.

The second data line DL2 may be electrically connected to some pixel circuits PC13, PC14, PC23, and PC24 among the plurality of pixel circuits PC11 to PC14 and PC21 to PC24.

In the first pixel row ROW1, the light emitting elements LD11, LD12, LD13, and LD14 may be sequentially arranged in the first direction DR1.

In the second pixel row ROW2, the light emitting elements LD21, LD22, LD23, and LD24 may be sequentially arranged in the first direction DR1.

The size, shape, and arrangement order of each of the plurality of light emitting elements LD11, LD12, LD13, LD14, LD21, LD22, LD23, LD24, LD32, and LD34 illustrated in FIG. 3A are merely examples to aid in understanding the description, and the present disclosure is not limited thereto.

In FIG. 3A, the plurality of light emitting elements LD11, LD12, LD13, LD14, LD21, LD22, LD23, LD24, LD32, and LD34 are illustrated as having an array form of PENTILE™, but the array form of the light emitting elements may have a stripe array form or an array form of Diamond Pixel™.

Some of the light emitting elements LD11 and LD23 among the plurality of light emitting elements LD11, LD12, LD13, LD14, LD21, LD22, LD23, LD24, LD32, and LD34 may each emit first light. For example, the first light may be red light.

Among the plurality of light emitting elements LD11, LD12, LD13, LD14, LD21, LD22, LD23, LD24, LD32, and LD34, other light emitting elements LD12, LD14, LD22, LD24, LD32, and LD34 may each emit second light different from the first light. For example, the second light may be green light.

Among the plurality of light emitting elements LD11, LD12, LD13, LD14, LD21, LD22, LD23, LD24, LD32, and LD34, the other light emitting elements LD13 and LD21 may each emit third light different from the first light and the second light. For example, the third light may be blue light.

The plurality of light emitting elements LD11, LD12, LD13, LD14, LD21, LD22, LD23, LD24, LD32, and LD34 may be electrically connected to the plurality of pixel circuits PC11 to PC14 and PC21 to PC24, respectively, through a plurality of extension wires EL11 to EL14 and EL21 to EL24.

The light emitting element LD11 may be electrically connected to the pixel circuit PC11 through a contact hole CT11 and the extension wire EL11 that extends in the first direction DR1. When viewed from above a plane or from a top-down perspective, the light emitting element LD11 may overlap the pixel circuit PC11.

The light emitting element LD12 may be electrically connected to the pixel circuit PC12 through a contact hole CT12 and the extension wire EL12 that extends in the second direction DR2. When viewed from above a plane or from a top-down perspective, the light emitting element LD12 may overlap at least two pixel circuits PC11 and PC12.

The light emitting element LD13 may be electrically connected to the pixel circuit PC13 through a contact hole CT13 and the extension wire EL13 that extends in the first direction DR1. When viewed from above a plane or from a top-down perspective, the light emitting element LD13 may overlap at least two pixel circuits PC12 and PC13.

The light emitting element LD14 may be electrically connected to the pixel circuit PC14 through a contact hole CT14 and the extension wire EL14 that extends in the second direction DR2. When viewed from above a plane or from a top-down perspective, the light emitting element LD14 may overlap at least two pixel circuits PC13 and PC14.

The light emitting element LD21 may be electrically connected to the pixel circuit PC21 through a contact hole CT21 and the extension wire EL21 extended in the first direction DR1. When viewed from above a plane or from a top-down perspective, the light emitting element LD21 may overlap the pixel circuit PC21.

The light emitting element LD22 may be electrically connected to the pixel circuit PC22 through a contact hole CT22 and the extension wire EL22 extended in the second direction DR2. When viewed from above a plane or from a top-down perspective, the light emitting element LD22 may overlap at least two pixel circuits PC21 and PC22.

The light emitting element LD23 may be electrically connected to the pixel circuit PC23 through a contact hole CT23 and the extension wire EL23 that extends in the first direction DR1. When viewed from above a plane, the light emitting element LD23 may overlap at least two pixel circuits PC22 and PC23.

The light emitting element LD24 may be electrically connected to the pixel circuit PC24 through a contact hole CT24 and the extension wire EL24 that extends in the second direction DR2. When viewed from above a plane or from a top-down perspective, the light emitting element LD24 may overlap at least two pixel circuits PC23 and PC24.

The data driving circuit 200 may output a first data signal Vdata1 to the first data line DL1 and may output a second data signal Vdata2 to the second data line DL2.

Two different types of color data may be provided to the one data line DL1 or DL2 during a horizontal period 1H by the pixel structure illustrated in FIG. 3A. That is, the data signal may be toggled during the horizontal period of 1H. For example, if a single data line toggles, it first carries one color data (e.g., red color data) and then switches to another color data (e.g., green color data) within the same horizontal period. The horizontal period 1H may be defined as a period of the horizontal period signal provided to the display panel DP.

The first data signal Vdata1 may sequentially provide first color data R11, second color data G12, third color data B21, and second color data G22. The first color data R11 and the second color data G12 may have a first voltage and a second voltage, respectively. The first voltage and second voltage may have different voltage levels from each other.

The second data signal Vdata2 may sequentially provide third color data B13, second color data G14, first color data R23, and second color data G24.

The first and third pieces of color data may have different voltage levels from each other. The first color data R11 or R23 may have the voltage level for displaying the first light. The second color data G12, G22, G14, or G24 may have a voltage level for displaying the second light. The third color data B21 or B13 may have a voltage level for displaying the third light.

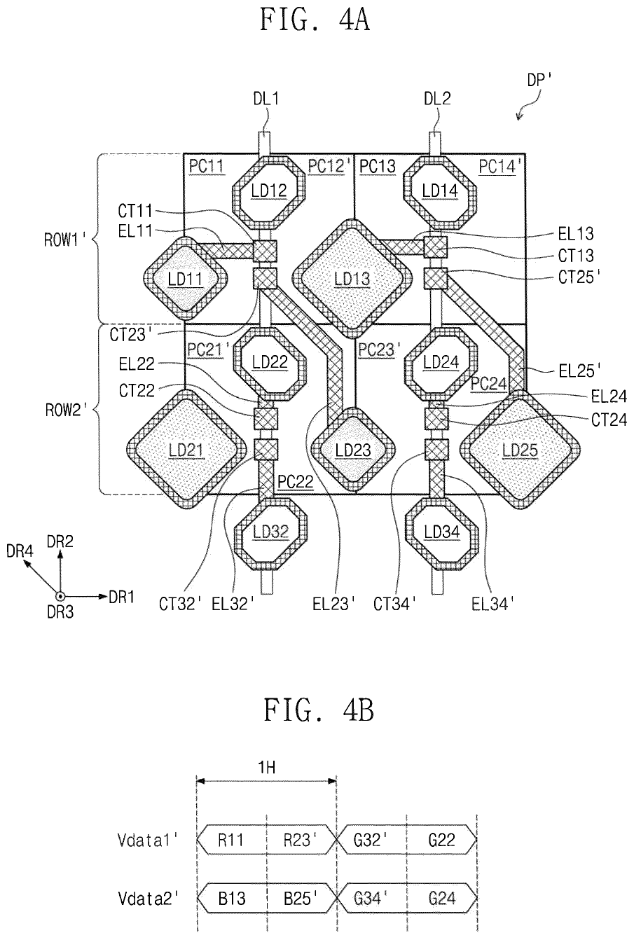

FIG. 4A illustrates a partial configuration of a display panel, according to an embodiment of the present disclosure. FIG. 4B is a timing diagram of data signals, according to an embodiment of the present disclosure. In the description of FIGS. 4A and 4B, the same reference numerals are assigned to the same components described with reference to FIGS. 3A and 3B, and thus the descriptions thereof are omitted to avoid redundancy.

Referring to FIGS. 2, 4A, and 4B, a display panel DP′ may include the plurality of data lines DL1 and DL2, a plurality of pixel circuits PC11, PC12′, PC13, PC14′, PC21′, PC22, PC23′, and PC24, and the plurality of light emitting elements LD11, LD12, LD13, LD14, LD21, LD22, LD23, LD24, LD32, and LD34.

The plurality of pixel circuits PC11, PC12′, PC13, PC14′, PC21′, PC22, PC23′, and PC24 and the plurality of light emitting elements LD11, LD12, LD13, LD14, LD21, LD22, LD23, LD24, LD32, and LD34 corresponding thereto may be included in the plurality of pixels PX11 to PXnm.

Among the plurality of pixel circuits PC11, PC12′, PC13, PC14′, PC21′, PC22, PC23′, and PC24, some pixel circuits PC11, PC12′, PC13, and PC14′ may be positioned in a first pixel row ROW1′ and may be sequentially arranged in the first direction DR1.

Among the plurality of pixel circuits PC11, PC12′, PC13, PC14′, PC21′, PC22, PC23′, and PC24, remaining pixel circuits PC21′, PC22, PC23′, and PC24 may be positioned in a second pixel row ROW2′ and may be sequentially arranged in the first direction DR1. The second pixel row ROW2′ may be spaced apart from the first pixel row ROW1′ in the second direction DR2.

The first data line DLI may be electrically connected to some pixel circuits PC11, PC12′, PC21′, and PC22 among the plurality of pixel circuits PC11, PC12′, PC13, PC14′, PC21′, PC22, PC23′, and PC24.

The second data line DL2 may be electrically connected to some pixel circuits PC13, PC14′, PC23′, and PC24 among the plurality of pixel circuits PC11, PC12′, PC13, PC14′, PC21′, PC22, PC23′, and PC24.

The light emitting element LD23 may be electrically connected to the pixel circuit PC12′ through a contact hole CT23′ and an extension wire EL23′ that extends in the second direction DR2 and a fourth direction DR4. In an embodiment, when viewed from above a plane or from a top-down perspective, the light emitting element LD23 does not overlap the pixel circuit PC12′. The fourth direction DR4 may intersect with the first direction DR1 and the second direction DR2. In an embodiment, when viewed from above a plane or from a top-down perspective, the light-emitting element LD23 is positioned in a region offset from the pixel circuit PC12′.

The light emitting elements LD11 and LD23, which are electrically connected to the two pixel circuits PC11 and PC12′ adjacent to each other in the first direction DR1, may emit light of the same color. For example, the light emitting elements LD11 and LD23 may emit light of the first color. The first light may be red light.

In an embodiment, the length of the extension wire EL11 connected to the light emitting element LD11 is shorter than the length of the extension wire EL23′ connected to the light emitting element LD23.

The light emitting element LD25 may be electrically connected to the pixel circuit PC14′ through a contact hole CT25′ and an extension wire EL25′ that extends in the second direction DR2 and the fourth direction DR4. In an embodiment, when viewed from above a plane or from a top-down perspective, the light emitting element LD25 does not overlap the pixel circuit PC14′. For example, when viewed from above a plane or from a top-down perspective, the light-emitting element LD25 is positioned in a region offset from the pixel circuit PC14′.

In an embodiment, the light emitting elements LD13 and LD25, which are electrically connected to the two pixel circuits PC13 and PC14′ adjacent to each other in the first direction DR1, emit light of the same color. For example, the light emitting elements LD13 and LD25 may emit light of the third color. The third light may be blue light.

In an embodiment, the length of the extension wire EL13 connected to the light emitting element LD13 is shorter than the length of the extension wire EL25′ connected to the light emitting element LD25.

The light emitting element LD32 may be electrically connected to the pixel circuit PC21′ through a contact hole CT32′ and an extension wire EL32′ that extends in the second direction DR2. In an embodiment, when viewed from above a plane or from a top-down perspective, the light emitting element LD32 does not overlap the pixel circuit PC21′. For example, when viewed from above a plane or from a top-down perspective, the light-emitting element LD32 is positioned in a region adjacent to the pixel circuit PC21′.

In an embodiment, the light emitting elements LD32 and LD22, which are electrically connected to the two pixel circuits PC21′ and PC22 adjacent to each other in the first direction DR1, emit light of the same color. For example, the light emitting elements LD32 and LD22 may emit light of the second color. The second light may be green light.

The light emitting element LD34 may be electrically connected to the pixel circuit PC23′ through a contact hole CT34′ and an extension wire EL34′ that extends in the second direction DR2. In an embodiment, when viewed from above a plane or from a top-down perspective, the light emitting element LD34 does not overlap the pixel circuit PC23′. For example, when viewed from above a plane or from a top-down perspective, the light-emitting element LD34 is positioned in a region offset from the pixel circuit PC23′.

In an embodiment, the light emitting elements LD34 and LD24, which are electrically connected to the two pixel circuits PC23′ and PC24 adjacent to each other in the first direction DR1, emit light of the same color. For example, the light emitting elements LD34 and LD24 may emit light of the second color.

The data driving circuit 200 may output a first data signal Vdata1′ to the first data line DL1 and may output a second data signal Vdata2′ to the second data line DL2.

Color data of a same color may be provided to a single data line DL1 or DL2 during the horizontal period 1H by the pixel structure illustrated in FIG. 4A. In the display panel DP′, color data is not toggled during the horizontal period of 1H. For example, color data of the same color may be provided throughout a single horizontal period.

The first data signal Vdata1′ may sequentially provide pieces of first color data R11 and R23′ and pieces of second color data G32′ and G22. The pieces of first color data R11 and R23′ may have a first voltage and a second voltage respectively.

The second data signal Vdata2′ may sequentially provide pieces of third color data B13 and B25′ and pieces of second color data G34′ and G24.

Equation 1 below may be used to calculate the power consumption ‘P’ of the data driving circuit 200.

$$\begin{matrix}[ Equation 1 ] & \\ P ∝ C \times Δ V * V * f & [ Equation 1 ]\end{matrix}$$

In Equation 1, ‘C’ may denote the load of the display panel DP; ‘V’ may denote a potential difference of a data signal Vdata; ΔV may denote a voltage effective value of the data signal Vdata; and ‘f’ may be denote the reciprocal of the toggle period of the data signal Vdata. In this case, the voltage effective value may be referred to as a root-mean-square (RMS) voltage.

According to an embodiment of the present disclosure, the power consumption P of the data driving circuit 200 may be proportional to the reciprocal of the toggle period of the data signal Vdata. A data signal may be provided to pixels of the same color as each other during one horizontal period. Charge/discharge operations may be eliminated depending on changes in the type of color data. The toggle period may be doubled. The frequency is halved, and thus the power consumption may be halved. Accordingly, the display panel DP′ with reduced power consumption may be provided.

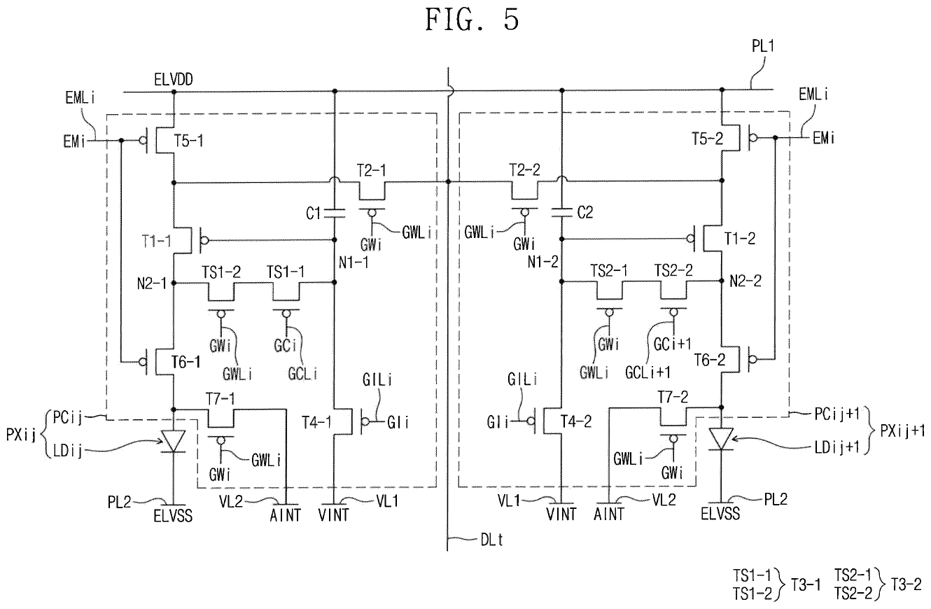

FIG. 5 is an equivalent circuit diagram illustrating pixels, according to an embodiment of the present disclosure.

Referring to FIGS. 2 and 5, two adjacent pixels among the plurality of pixels PX11 to PXnm may have the same circuit configuration as the equivalent circuit diagram of pixels PXij and PXij+1.

The plurality of scan lines GL1 to GLn may include a plurality of first scan lines, a plurality of second scan lines, and a plurality of third scan lines.

Two adjacent pixels PXij and PXij+1 may be connected to a t-th data line DLt among the data lines DL1 to DLl, an i-th first scan line GWLi among the plurality of first scan lines, i-th and (i+1)-th second scan lines GCLi and GCLi+1 among the plurality of second scan lines, an i-th third scan line GILi among the plurality of third scan lines, and an i-th emission control line EMLi among the plurality of emission control lines EML1 to EMLk.

The (i+1)-th second scan signal GCi+1 may be a signal obtained by delaying the i-th second scan signal GCi by a predetermined delay time t calculated according to the following Equation 2.

$$t = \frac{j + 1}{2} \qquad [ Equation 2 ]$$

In Equation 2, j represents the pixel's column index in a row.

The two adjacent pixels PXij and PXij+1 may include the first pixel PXij and the second pixel PXij+1. For example, if i=2 and j=3, the adjacent pixels would be pixel PX_{2,3} in row 2, column 3; and pixel PX_{2,4} in row 2, column 4; and t=(3+1)/2=2 time units for the second scan signal GCi+1 compared to GCi. However, if i=1 and j=5; the adjacent pixels would be pixel PX_{1,5} in row 1, column 5; and pixel PX_{1,6} in row 1, column 6; and t=(5+1)/2=3 time units for the second scan signal GCi+1 compared to the first scan signal GCi. As j increases, the delay time t increases. This staggered delay may ensure sequential activation of scan signals, preventing signal interference while maintaining efficient pixel operation. For example, the first driving circuit SD may provide the first scan signal GCi and the second driving circuit EDC may provide the second scan signal GCi+1. For example, the second driving circuit EDC may include an additional delay circuit to generate the second scan signal GCi+1.

The first pixel PXij may include a first light emitting element LDij and a first pixel circuit PCij. The second pixel PXij+1 may include a second light emitting element LDij+1 and a second pixel circuit PCij+1. Each of the first light emitting element LDij and the second light emitting element LDij+1 may be a light emitting diode. For example, each of the first light emitting element LDij and the second light emitting element LDij+1 may be an organic light emitting diode including an organic light emitting layer. The first pixel circuit PCij and the second pixel circuit PCij+1 may be connected to the first light emitting element LDij and the second light emitting element LDij+1, respectively. The first pixel circuit PCij and the second pixel circuit PCij+1 may control the amount of current flowing to the first light emitting element LDij and the second light emitting element LDij+1, respectively. The first light emitting element LDij and the second light emitting element LDij+1 may generate light having a predetermined luminance depending on the amount of current.

The first pixel circuit PCij may include a 1-1st transistor T1-1, a 2-1st transistor T2-1, a 3-1st transistor T3-1, a 4-1st transistor T4-1, a 5-1st transistor T5-1, a 6-1st transistor T6-1, a 7-1st transistor T7-1, and a first capacitor C1.

The second pixel circuit PCij+1 may include a 1-2nd transistor T1-2, a 2-2nd transistor T2-2, a 3-2nd transistor T3-2, a 4-2nd transistor T4-2, a 5-2nd transistor T5-2, a 6-2nd transistor T6-2, a 7-2nd transistor T7-2, and a second capacitor C2.

In an embodiment of the present disclosure, each of the first pixel circuit PCij and the second pixel circuit PCij+1 may be referred to as having a 7T1C structure.

Each of the transistors may be a P-type transistor having a low-temperature polycrystalline silicon (LTPS) semiconductor layer. However, this is merely an example. For example, the semiconductor layer according to an embodiment of the present disclosure is not limited thereto, and may include an oxide semiconductor, crystalline silicon, or the like. However, this is merely an example, and all of transistors according to an embodiment of the present disclosure are N-type transistors. In an embodiment, at least one of the transistors are a P-type transistor, and the others thereof are N-type transistors.

The first scan line GWLi may deliver a first scan signal GWi; the second scan lines GCLi and GCLi+1 may deliver second scan signals GCi and GCi+1; and, the third scan line GILi may deliver a third scan signal GIi.

A first power source line PL1 may provide the first power source ELVDD. A second power source line PL2 may provide the second power source ELVSS. The second power source ELVSS may have a lower voltage level than the first power source ELVDD. A first voltage line VL1 may provide the first initialization voltage VINT. A second voltage line VL2 may provide the second initialization voltage AINT.

The first light emitting element LDij may be connected between the second power source line PL2 and the 6-1st transistor T6-1. The first light emitting element LDij may include a first electrode and a second electrode. The first electrode may be referred to as an “anode electrode”, and the second electrode may be referred to as a “cathode electrode”. The first electrode may be electrically connected to the first power source line PL1 via the 6-1st transistor T6-1, the 1-1st transistor T1-1, and the 5-1st transistor T5-1. The second electrode may be electrically connected to the second power source line PL2.

The 1-1st transistor T1-1 may be electrically connected between a 2-1st node N2-1 and the first power source line PL1. The 1-1st transistor T1-1 may include a gate electrode connected to a 1-1st node N1-1, a first electrode connected to the 2-1st node N2-1, and a second electrode electrically connected to the first power source line PL1 via the 5-1st transistor T5-1. The 1-1st transistor T1-1 may be referred to as a “driving transistor”. The first electrode of the 1-1st transistor T1-1 may be electrically connected to the first light emitting element LDij via the 6-1st transistor T6-1.

The 2-1st transistor T2-1 may be connected to the data line DLt. The 2-1st transistor T2-1 may include a gate electrode to which the first scan signal GWi is provided, a first electrode electrically connected to the data line DLt, and a second electrode connected to the second electrode of the 1-1st transistor T1-1. The 2-1st transistor T2-1 may be referred to as a “switch transistor”. The gate electrode of the 2-1st transistor T2-1 may be connected to the first scan line GWLi.

The 3-1st transistor T3-1 may be connected between the 1-1st node N1-1 and the 2-1st node N2-1. The 3-1st transistor T3-1 may be provided as a “dual transistor” and may be referred to as a “charge transfer transistor”. In an embodiment, the 3-1st transistor T3-1 includes a 1-1st sub-transistor TS1-1 and a 1-2nd sub-transistor TS1-2 connected in series with one another.

The i-th second scan signal GCi may be applied to the 1-1st sub-transistor TS1-1. The 1-1st sub-transistor TS1-1 may be connected between the 1-1st node N1-1 and the 1-2nd sub-transistor TS1-2. The 1-1st sub-transistor TS1-1 may include a gate electrode to which the second scan signal GCi is provided, a first electrode connected to the 1-1st node N1-1, and a second electrode connected to the 1-2nd sub-transistor TS1-2. The gate electrode of the 1-1st sub-transistor TS1-1 may be connected to the second scan line GCLi.

The i-th first scan signal GWi may be applied to the 1-2nd sub-transistor TS1-2. The 1-2nd sub-transistor TS1-2 may be connected between the 2-1st node N2-1 and the 1-1st sub-transistor TS1-1. The 1-2nd sub-transistor TS1-2 may include a gate electrode to which the first scan signal GWi is provided, a first electrode connected to the 1-1st sub-transistor TS1-1, and a second electrode connected to the 2-1st node N2-1. The gate electrode of the 1-2nd sub-transistor TS1-2 may be connected to the first scan line GWLi.

The 4-1st transistor T4-1 may be connected between the 1-1st node N1-1 and the first voltage line VL1. The i-th third scan signal GIi may be applied to the 4-1st transistor T4-1. The 4-1st transistor T4-1 may include a gate electrode to which the third scan signal GIi is provided, a first electrode connected to the 1-1st node N1-1, and a second electrode connected to the first voltage line VL1. The gate electrode of the 4-1st transistor T4-1 may be connected to the third scan line GILi.

The emission control signal EMi may be applied to the 5-1st transistor T5-1. The 5-1st transistor T5-1 may be connected between the first power source line PL1 and the 1-1st transistor T1-1. The 5-1st transistor T5-1 may include a gate electrode to which the emission control signal EMi is provided, a first electrode connected to the first power source line PL1, and a second electrode connected to the 1-1st transistor T1-1. The gate electrode of the 5-1st transistor T5-1 may be connected to the emission control line EMLi.

The emission control signal EMi may be applied to the 6-1st transistor T6-1. The 6-1st transistor T6-1 may be connected between the first light emitting element LDij and the 1-1st transistor T1-1. The 6-1st transistor T6-1 may include a gate electrode to which the emission control signal EMi is provided, a first electrode connected to the first light emitting element LDij, and a second electrode connected to the 1-1st transistor T1-1. The gate electrode of the 6-1st transistor T6-1 may be connected to the emission control line EMLi.

The i-th first scan signal GWi may be applied to the 7-1st transistor T7-1. The 7-1st transistor T7-1 may be connected between the first light emitting element LDij and the second voltage line VL2. The 7-1st transistor T7-1 may include a gate electrode to which the first scan signal GWi is provided, a first electrode connected to the first light emitting element LDij, and a second electrode connected to the second voltage line VL2. The gate electrode of the 7-1st transistor T7-1 may be connected to the first scan line GWLi.

The first capacitor C1 may be connected between the first power source line PL1 and the 1-1st node N1-1. The first capacitor C1 may be referred to as a “storage capacitor”.

The light emitting element LDij+1 may be connected between the second power source line PL2 and the 6-2nd transistor T6-2. The second light emitting element LDij+1 may include a first electrode and a second electrode. The first electrode may be electrically connected to the first power source line PL1 via the 6-2nd transistor T6-2, the 1-2nd transistor T1-2, and the 5-2nd transistor T5-2. The second electrode may be electrically connected to the second power source line PL2.

The 1-2nd transistor T1-2 may be electrically connected between a 2-2nd node N2-2 and the first power source line PL1. The 1-2nd transistor T1-2 may include a gate electrode connected to a 1-2nd node N1-2, a first electrode connected to the 2-2nd node N2-2, and a second electrode electrically connected to the first power source line PL1 via the 5-2nd transistor T5-2. The 1-2nd transistor T1-2 may be referred to as a “driving transistor”. The first electrode of the 1-2nd transistor T1-2 may be electrically connected to the second light emitting element LDij+1 via the 6-2nd transistor T6-2.

The 2-2nd transistor T2-2 may be connected to the data line DLt. The 2-2nd transistor T2-2 may include a gate electrode to which the first scan signal GWi is provided, a first electrode electrically connected to the data line DLt, and a second electrode connected to the second electrode of the 1-2nd transistor T1-2. The 2-2nd transistor T2-2 may be referred to as a “switch transistor”. The gate electrode of the 2-2nd transistor T2-2 may be connected to the first scan line GWLi.

According to an embodiment of the present disclosure, the one data line DLt is connected to two adjacent pixels PXij and PXij+1. The data line DLt may be connected to the 2-1st transistor T2-1 and the 2-2nd transistor T2-2. The number of data lines DL1 to DLl may be smaller than the number of pixels PX11 to PX1m arranged in the first direction DR1. The number of IC chips included in the data driving circuit 200 may be reduced by reducing the number of channels of the plurality of data lines DL1 to DLl. Accordingly, the power consumption of the data driving circuit 200 may be reduced, and the display device 1000 with the reduced area size of the peripheral area NA may be provided.

The 3-2nd transistor T3-2 may be connected between the 1-2nd node N1-2 and the 2-2nd node N2-2. The 3-2nd transistor T3-2 may be provided as a “dual transistor” and referred to as a “charge transfer transistor”. The 3-2nd transistor T3-2 may include a 2-1st sub-transistor TS2-1 and a 2-2nd sub-transistor TS2-2 connected in series with one another.

The i-th first scan signal GWi may be applied to the 2-1st sub-transistor TS2-1. The 2-1st sub-transistor TS2-1 may be connected between the 1-2nd node N1-2 and the 2-2nd sub-transistor TS2-2. The 2-1st sub-transistor TS2-1 may include a gate electrode to which the first scan signal GWi is provided, a first electrode connected to the 1-2nd node N1-2, and a second electrode connected to the 2-2nd sub-transistor TS2-2. The gate electrode of the 2-1st sub-transistor TS2-1 may be connected to the first scan line GWLi.

The (i+1)-th second scan signal GCi+1 may be applied to the 2-2nd sub-transistor TS2-2. The 2-2nd sub-transistor TS2-2 may be connected between the 2-2nd node N2-2 and the 2-1st sub-transistor TS2-1. The 2-2nd sub-transistor TS2-2 may include a gate electrode to which the second scan signal GCi+1 is provided, a first electrode connected to the 2-1st sub-transistor TS2-1, and a second electrode connected to the 2-2nd node N2-2. The gate electrode of the 2-2nd sub-transistor TS2-2 may be connected to the (i+1)-th second scan line GCLi+1.

The 4-2nd transistor T4-2 may be connected between the 1-2nd node N1-2 and the first voltage line VL1. The i-th third scan signal GIi may be applied to the 4-2nd transistor T4-2. The 4-2nd transistor T4-2 may include a gate electrode to which the third scan signal GIi is provided, a first electrode connected to the 1-2nd node N1-2, and a second electrode connected to the first voltage line VL1. The gate electrode of the 4-2nd transistor T4-2 may be connected to the third scan line GILi.

The scan signal applied to each of the 4-1st transistor T4-1 and the 4-2nd transistor T4-2 according to an embodiment of the present disclosure is not limited thereto. For example, the third scan signal GIi may be a (i−1)-th first scan signal GWi−1.

The emission control signal EMi may be applied to the 5-2nd transistor T5-2. The 5-2nd transistor T5-2 may be connected between the first power source line PL1 and the 1-2nd transistor T1-2. The 5-2nd transistor T5-2 may include a gate electrode to which the emission control signal EMi is provided, a first electrode connected to the first power source line PL1, and a second electrode connected to the 1-2nd transistor T1-2. The gate electrode of the 5-2nd transistor T5-2 may be connected to the emission control line EMLi.

The emission control signal EMi may be applied to the 6-2nd transistor T6-2. The 6-2nd transistor T6-2 may be connected between the second light emitting element LDij+1 and the 1-2nd transistor T1-2. The 6-2nd transistor T6-2 may include a gate electrode to which the emission control signal EMi is provided, a first electrode connected to the second light emitting element LDij+1, and a second electrode connected to the 1-2nd transistor T1-2. The gate electrode of the 6-2nd transistor T6-2 may be connected to the emission control line EMLi.

The i-th first scan signal GWi may be applied to the 7-2nd transistor T7-2. The 7-2nd transistor T7-2 may be connected between the second light emitting element LDij+1 and the second voltage line VL2. The 7-2nd transistor T7-2 may be connected to a gate electrode to which the first scan signal GWi is provided, a first electrode connected to the second light emitting element LDij+1, and a second electrode connected to the second voltage line VL2. The gate electrode of the 7-2nd transistor T7-2 may be connected to the first scan line GWLi.

The second capacitor C2 may be connected between the first power source line PL1 and the 1-2nd node N1-2. The second capacitor C2 may be referred to as a “storage capacitor”.

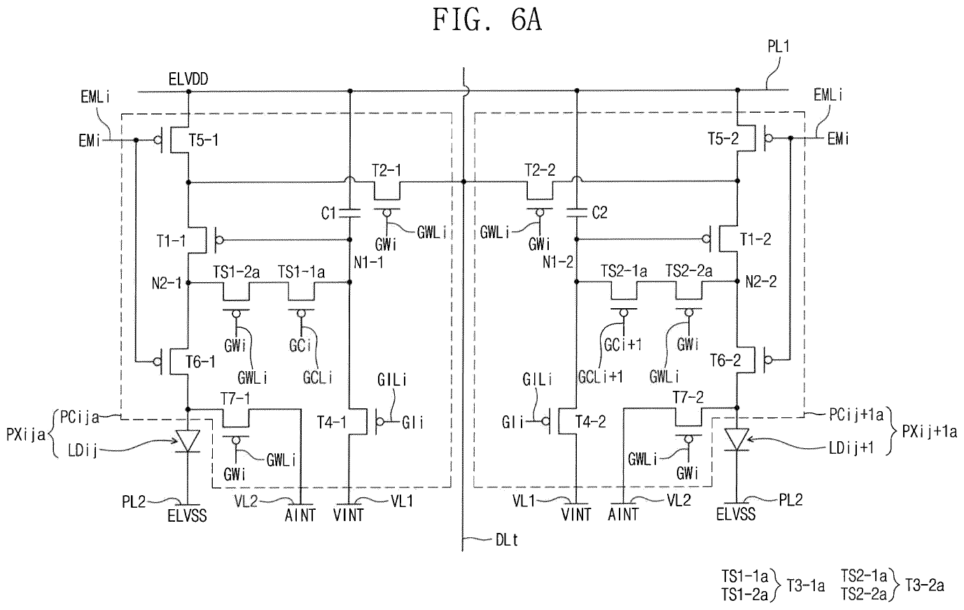

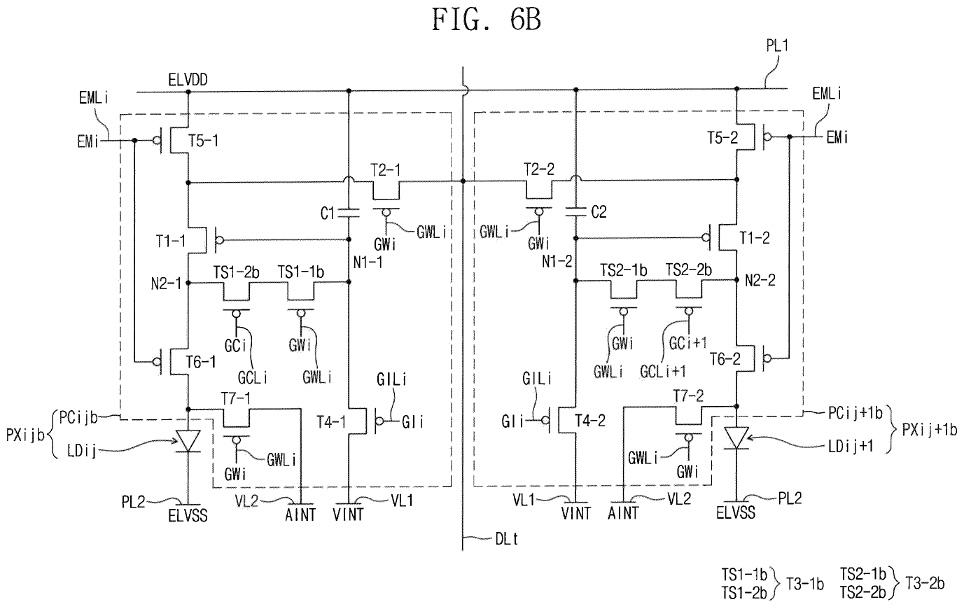

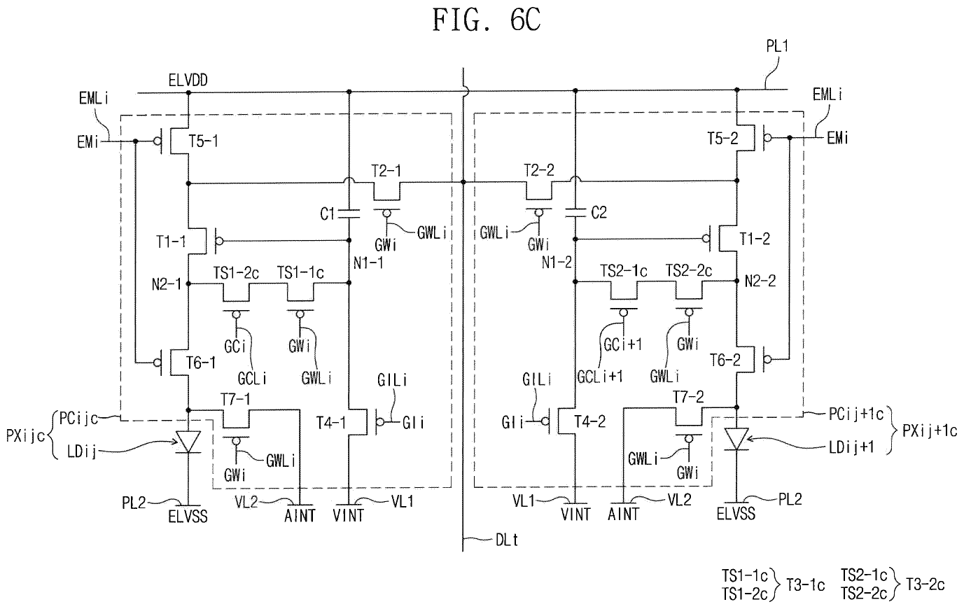

FIG. 6A is an equivalent circuit diagram illustrating pixels, according to an embodiment of the present disclosure. In the description of FIG. 6A, the same reference numerals are assigned to the same components described with reference to FIG. 5, and thus the descriptions thereof are omitted.

Referring to FIG. 6A, a first pixel PXija may include the first light emitting element LDij and a first pixel circuit PCija. A second pixel PXij+1a may include the second light emitting element LDij+1 and a second pixel circuit PCij+1a.

The first pixel circuit PCija may include the 1-1st transistor T1-1, the 2-1st transistor T2-1, a 3-1st transistor T3-1a, the 4-1st transistor T4-1, the 5-1st transistor T5-1, the 6-1st transistor T6-1, the 7-1st transistor T7-1, and the first capacitor C1.

The second pixel circuit PCij+1a may include the 1-2nd transistor T1-2, the 2-2nd transistor T2-2, a 3-2nd transistor T3-2a, the 4-2nd transistor T4-2, the 5-2nd transistor T5-2, the 6-2nd transistor T6-2, the 7-2nd transistor T7-2, and the second capacitor C2.

The 3-1st transistor T3-1a may be connected between the 1-1st node N1-1 and the 2-1st node N2-1. The 3-1st transistor T3-1a may be provided as a “dual transistor” and referred to as a “charge transfer transistor”. The 3-1st transistor T3-1a may include a 1-1st sub-transistor TS1-1a and a 1-2nd sub-transistor TS1-2a connected in series with one another.

The i-th second scan signal GCi may be applied to the 1-1st sub-transistor TS1-1a. The 1-1st sub-transistor TS1-1a may be connected between the 1-1st node N1-1 and the 1-2nd sub-transistor TS1-2a. The 1-1st sub-transistor TS1-1a may include a gate electrode to which the second scan signal GCi is provided, a first electrode connected to the 1-1st node N1-1, and a second electrode connected to the 1-2nd sub-transistor TS1-2a. The gate electrode of the 1-1st sub-transistor TS1-1a may be connected to the second scan line GCLi.

The i-th first scan signal GWi may be applied to the 1-2nd sub-transistor TS1-2a. The 1-2nd sub-transistor TS1-2a may be connected between the 2-1st node N2-1 and the 1-1st sub-transistor TS1-1a. The 1-2nd sub-transistor TS1-2a may include a gate electrode to which the first scan signal GWi is provided, a first electrode connected to the 1-1st sub-transistor TS1-1a, and a second electrode connected to the 2-1st node N2-1. The gate electrode of the 1-2nd sub-transistor TS1-2a may be connected to the first scan line GWLi.

The 3-2nd transistor T3-2a may be connected between the 1-2nd node N1-2 and the 2-2nd node N2-2. The 3-2nd transistor T3-2a may be provided as a “dual transistor” and referred to as a “charge transfer transistor. The 3-2nd transistor T3-2amay include a 2-1st sub-transistor TS2-1a and a 2-2nd sub-transistor TS2-2a connected in series with one another.

The (i+1)-th second scan signal GCi+1 may be applied to the 2-1st sub-transistor TS2-1a. The 2-1st sub-transistor TS2-1a may be connected between the 1-2nd node N1-2 and the 2-2nd sub-transistor TS2-2a. The 2-1st sub-transistor TS2-1a may include a gate electrode to which the second scan signal GCi+1 is provided, a first electrode connected to the 2-2nd sub-transistor TS2-2a, and a second electrode connected to the 1-2nd node N1-2. The gate electrode of the 2-1st sub-transistor TS2-1a may be connected to the (i+1)-th second scan line GCLi+1.

The i-th first scan signal GWi may be applied to the 2-2nd sub-transistor TS2-2a. The 2-2nd sub-transistor TS2-2a may be connected between the 2-2nd node N2-2 and the 2-1st sub-transistor TS2-1a. The 2-2nd sub-transistor TS2-2a may include a gate electrode to which the first scan signal GWi is provided, a first electrode connected to the 2-2nd node N2-2, and a second electrode connected to the 2-1st sub-transistor TS2-1a. The gate electrode of the 2-2nd sub-transistor TS2-2a may be connected to the first scan line GWLi.

FIG. 6B is an equivalent circuit diagram illustrating pixels, according to an embodiment of the present disclosure. In the description of FIG. 6B, the same reference numerals are assigned to the same components described with reference to FIG. 5, and thus the descriptions thereof are omitted.

Referring to FIG. 6B, a first pixel PXijb may include the first light emitting element LDij and a first pixel circuit PCijb. A second pixel PXij+1b may include the second light emitting element LDij+1 and a second pixel circuit PCij+1b.

The first pixel circuit PCijb may include the 1-1st transistor T1-1, the 2-1st transistor T2-1, a 3-1st transistor T3-1b, the 4-1st transistor T4-1, the 5-1st transistor T5-1, the 6-1st transistor T6-1, the 7-1st transistor T7-1, and the first capacitor C1.

The second pixel circuit PCij+1b may include the 1-2nd transistor T1-2, the 2-2nd transistor T2-2, a 3-2nd transistor T3-2b, the 4-2nd transistor T4-2, the 5-2nd transistor T5-2, the 6-2nd transistor T6-2, the 7-2nd transistor T7-2, and the second capacitor C2.

The 3-1st transistor T3-1b may be connected between the 1-1st node N1-1 and the 2-1st node N2-1. The 3-1st transistor T3-1b may be provided as a “dual transistor” and referred to as a “charge transfer transistor”. The 3-1st transistor T3-1b may include a 1-1st sub-transistor TS1-1b and a 1-2nd sub-transistor TS1-2b connected in series with one another.

The i-th first scan signal GWi may be applied to the 1-1st sub-transistor TS1-1b. The 1-1st sub-transistor TS1-1b may be connected between the 1-1st node N1-1 and the 1-2nd sub-transistor TS1-2b. The 1-1st sub-transistor TS1-1b may include a gate electrode to which the first scan signal GWi is provided, a first electrode connected to the 1-2nd sub-transistor TS1-2b, and a second electrode connected to the 1-1st node N1-1. The gate electrode of the 1-1st sub-transistor TS1-1b may be connected to the first scan line GWLi.

The i-th second scan signal GCi may be applied to the 1-2nd sub-transistor TS1-2b. The 1-2nd sub-transistor TS1-2b may be connected between the 2-1st node N2-1 and the 1-1st sub-transistor TS1-1b. The 1-2nd sub-transistor TS1-2b may include a gate electrode to which the second scan signal GCi is provided, a first electrode connected to the 2-1st node N2-1, and a second electrode connected to the 1-1st sub-transistor TS1-1b. The gate electrode of the 1-2nd sub-transistor TS1-2b may be connected to the second scan line GCLi.

The 3-2nd transistor T3-2b may be connected between the 1-2nd node N1-2 and the 2-2nd node N2-2. The 3-2nd transistor T3-2b may be provided as a “dual transistor” and referred to as a “charge transfer transistor”. The 3-2nd transistor T3-2b may include a 2-1st sub-transistor TS2-1b and a 2-2nd sub-transistor TS2-2b.

The i-th first scan signal GWi may be applied to the 2-1st sub-transistor TS2-1b. The 2-1st sub-transistor TS2-1b may be connected between the 1-2nd node N1-2 and the 2-2nd sub-transistor TS2-2b. The 2-1st sub-transistor TS2-1b may include a gate electrode to which the first scan signal GWi is provided, a first electrode connected to the 1-2nd node N1-2, and a second electrode connected to the 2-2nd sub-transistor TS2-2b. The gate electrode of the 2-1st sub-transistor TS2-1b may be connected to the first scan line GWLi.

The (i+1)-th second scan signal GCi+1 may be applied to the 2-2nd sub-transistor TS2-2b. The 2-2nd sub-transistor TS2-2b may be connected between the 2-2nd node N2-2 and the 2-1st sub-transistor TS2-1b. The 2-2nd sub-transistor TS2-2b may include a gate electrode to which the second scan signal GCi+1 is provided, a first electrode connected to the 2-1st sub-transistor TS2-1b, and a second electrode connected to the 2-2nd node N2-2. The gate electrode of the 2-2nd sub-transistor TS2-2b may be connected to the (i+1)-th second scan line GCLi+1.

FIG. 6C is an equivalent circuit diagram illustrating pixels, according to an embodiment of the present disclosure. In the description of FIG. 6C, the same reference numerals are assigned to the same components described with reference to FIG. 5, and thus the descriptions thereof are omitted.

Referring to FIG. 6C, a first pixel PXijc may include the first light emitting element LDij and a first pixel circuit PCijc. A second pixel PXij+1c may include the second light emitting element LDij+1 and a second pixel circuit PCij+1c.

The first pixel circuit PCijc may include the 1-1st transistor T1-1, the 2-1st transistor T2-1, a 3-1st transistor T3-1c, the 4-1st transistor T4-1, the 5-1st transistor T5-1, the 6-1st transistor T6-1, the 7-1st transistor T7-1, and the first capacitor C1.

The second pixel circuit PCij+1c may include the 1-2nd transistor T1-2, the 2-2nd transistor T2-2, a 3-2nd transistor T3-2c, the 4-2nd transistor T4-2, the 5-2nd transistor T5-2, the 6-2nd transistor T6-2, the 7-2nd transistor T7-2, and the second capacitor C2.

The 3-1st transistor T3-1c may be connected between the 1-1st node N1-1 and the 2-1st node N2-1. The 3-1st transistor T3-1c may be provided as a “dual transistor”. The 3-1st transistor T3-1c may include a 1-1st sub-transistor TS1-1c and a 1-2nd sub-transistor TS1-2c.

The i-th first scan signal GWi may be applied to the 1-1st sub-transistor TS1-1c. The 1-1st sub-transistor TS1-1c may be connected between the 1-1st node N1-1 and the 1-2nd sub-transistor TS1-2c. The 1-1st sub-transistor TS1-1c may include a gate electrode to which the first scan signal GWi is provided, a first electrode connected to the 1-2nd sub-transistor TS1-2c, and a second electrode connected to the 1-1st node N1-1. The gate electrode of the 1-1st sub-transistor TS1-1c may be connected to the first scan line GWLi.

The i-th second scan signal GCi may be applied to the 1-2nd sub-transistor TS1-2c. The 1-2nd sub-transistor TS1-2c may be connected between the 2-1st node N2-1 and the 1-1st sub-transistor TS1-1c. The 1-2nd sub-transistor TS1-2c may include a gate electrode to which the second scan signal GCi is provided, a first electrode connected to the 2-1st node N2-1, and a second electrode connected to the 1-1st sub-transistor TS1-1c. The gate electrode of the 1-2nd sub-transistor TS1-2c may be connected to the second scan line GCLi.

The 3-2nd transistor T3-2c may be connected between the 1-2nd node N1-2 and the 2-2nd node N2-2. The 3-2nd transistor T3-2c may be provided as a “dual transistor” and referred to as a “charge transfer transistor”. The 3-2nd transistor T3-2c may include a 2-1st sub-transistor TS2-1c and a 2-2nd sub-transistor TS2-2c connected in series with one another.

The (i+1)-th second scan signal GCi+1 may be applied to the 2-1st sub-transistor TS2-1c. The 2-1st sub-transistor TS2-1c may be connected between the 1-2nd node N1-2 and the 2-2nd sub-transistor TS2-2c. The 2-1st sub-transistor TS2-1c may include a gate electrode to which the second scan signal GCi+1 is provided, a first electrode connected to the 2-2nd sub-transistor TS2-2c, and a second electrode connected to the 1-2nd node N1-2. The gate electrode of the 2-1st sub-transistor TS2-1c may be connected to the (i+1)-th second scan line GCLi+1.

The i-th first scan signal GWi may be applied to the 2-2nd sub-transistor TS2-2c. The 2-2nd sub-transistor TS2-2c may be connected between the 2-2nd node N2-2 and the 2-1st sub-transistor TS2-1c. The 2-2nd sub-transistor TS2-2c may include a gate electrode to which the first scan signal GWi is provided, a first electrode connected to the 2-2nd node N2-2, and a second electrode connected to the 2-1st sub-transistor TS2-1c. The gate electrode of the 2-2nd sub-transistor TS2-2c may be connected to the first scan line GWLi.

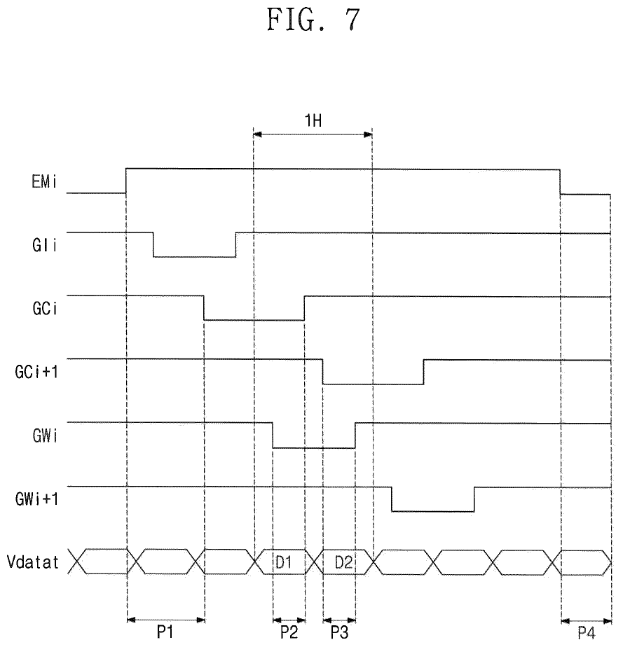

FIG. 7 is a timing diagram for describing an operation of a display device, according to an embodiment of the present disclosure.

Referring to FIGS. 2, 5, and 7, the display panel DP may display the image IM (see FIG. 1) by operating in units of frame periods. The one frame period may include first to fourth periods P1, P2, P3, and P4.

The first to third periods P1, P2, and P3 may be referred to as non-emission periods. In detail, the first period P1 may be referred to as an initialization period. The second period P2 may be referred to as a “first data write period”. The third period P3 may be referred to as a “second data write period”. The fourth period P4 may be referred to as an “emission period”.

The emission control signal EMi may be provided through the i-th emission control line EMLi. An active level of the emission control signal EMi may be a low level. The third scan signal GIi may be provided through the i-th third scan line GILi. An active level of the third scan signal GIi may be a low level.

The second scan signal GCi may be provided through the i-th second scan line GCLi. The second scan signal GCi+1 may be provided through the (i+1)-th second scan line GCLi+1. The (i+1)-th second scan signal GCi+1 may be a signal obtained by shifting or delaying the i-th second scan signal GCi by a predetermined time. An active level of the second scan signals GCi and GCi+1 may be a low level.

The first scan signal GWi may be provided through the i-th first scan line GWLi. The (i+1)-th first scan signal GWi+1 may be a signal obtained by shifting or delaying the i-th first scan signal GWi by a predetermined time. Active levels of the first scan signals GWi and GWi+1 may be low levels.

A data signal Vdatat may be provided through the data line DLt. Two pieces of color data D1 and D2 may be provided during the horizontal period 1H in the data signal Vdatat. That is, the data signal may be toggled during the horizontal period of 1H. The first color data D1 may have a first voltage, and the second color data D2 may have a second voltage. For example, the first color data D1 may be color data of a first color and the second color data D2 may be color data of a second color different from the first color. In this case, voltage levels of the first voltage and the second voltage may be different from each other.

FIG. 7 illustrates a case having the structure illustrated in FIG. 3A. However, this is merely an example. When the data signal Vdatat according to an embodiment of the present disclosure has the structure shown in FIG. 4A, a data signal having the same color during the horizontal period 1H is provided as shown in FIG. 4B.

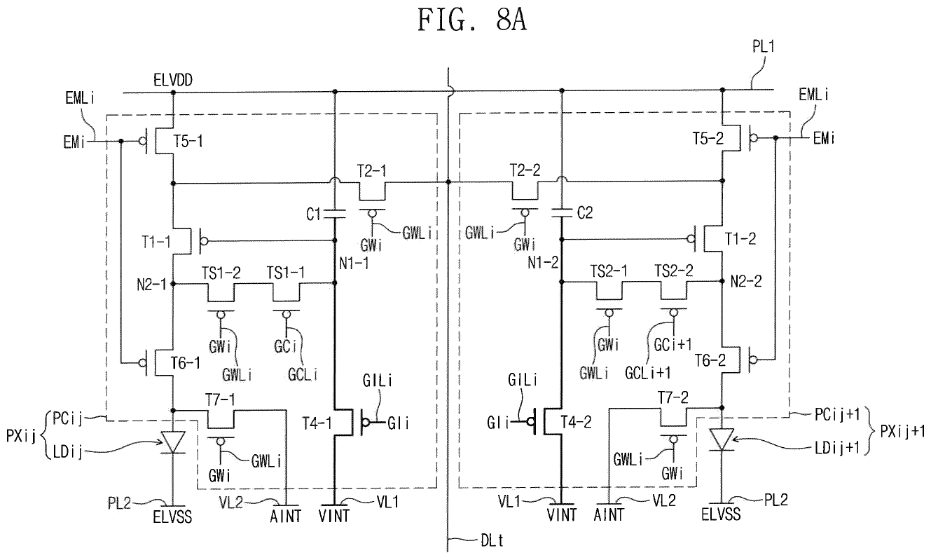

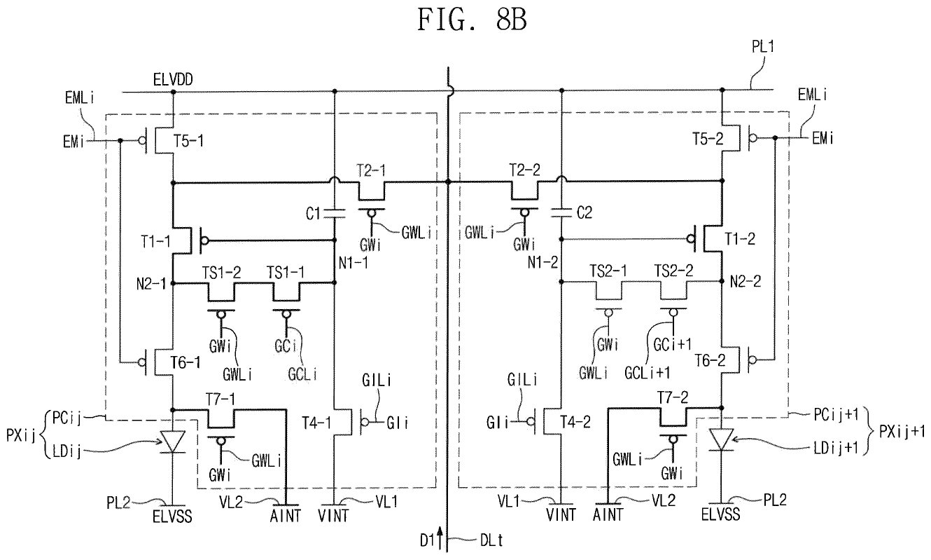

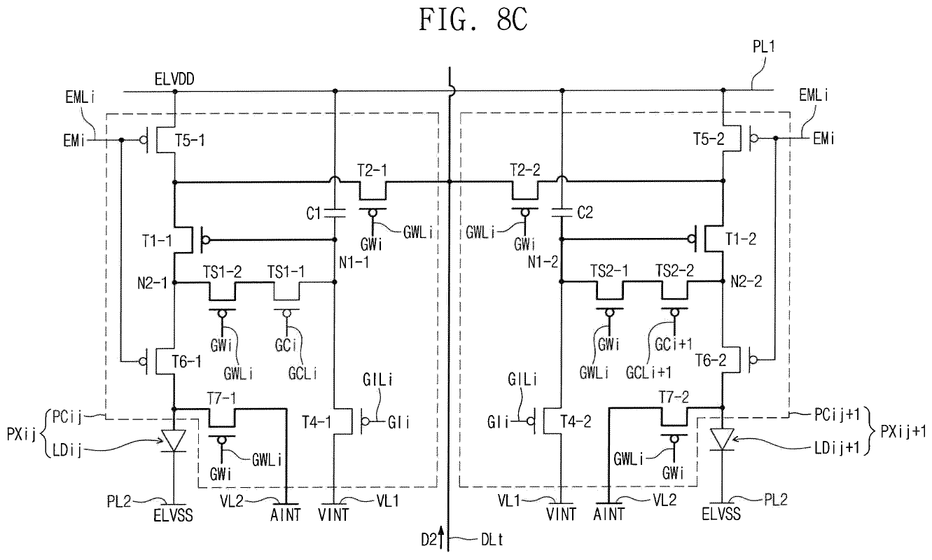

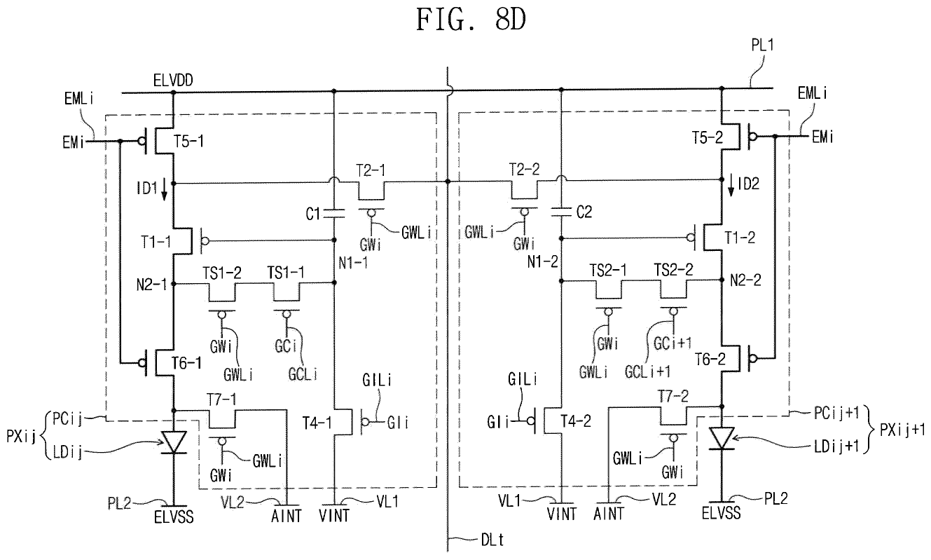

FIGS. 8A to 8D are diagrams for describing an operation of a pixel, according to an embodiment of the present disclosure. In the description of FIGS. 8A to 8D, the same reference numerals are assigned to the same components described with reference to FIG. 5, and thus the descriptions thereof are omitted.

Referring to FIGS. 7 and 8A, one period of the third scan signal GIi in the first period P1 may be an active level.

The 4-1st transistor T4-1 and the 4-2nd transistor T4-2 may be turned on in response to the third scan signal GIi. For example, the 4-1st transistor T4-1 and the 4-2nd transistor T4-2 are illustrated in FIG. 8A in bold to indicate they are turned on.

The first initialization voltage VINT may be provided to the 1-1st node N1-1 via the 4-1st transistor T4-1. In other words, the gate electrode of the 1-1st transistor T1-1 may be charged to the first initialization voltage VINT. The residual current of the gate electrode of the 1-1st transistor T1-1 may be eliminated.

The first initialization voltage VINT may be provided to the 1-2nd node N1-2 via the 4-2nd transistor T4-2. In other words, the gate electrode of the 1-2nd transistor T1-2 may be charged to the first initialization voltage VINT. The residual current of the gate electrode of the 1-2nd transistor T1-2 may be eliminated.

According to an embodiment of the present disclosure, afterward, before the compensation of a threshold voltage (referred to as “Vth”) of each of the driving transistors T1-1 and T1-2 in the second period P2 and the third period P3, the residual current of the nodes N1-1 and N1-2 on a compensation path may be eliminated. Defects caused by the residual current may be prevented. In this way, compensation for the threshold voltage of each of the driving transistors T1-1 and T1-2 may be performed. Accordingly, the display device 1000 (see FIG. 2) with increased display quality may be provided.

Referring to FIGS. 7 and 8B, the second period P2 may occur after the first period P1. In the second period P2, the i-th first scan signal GWi and the i-th second scan signal GCi may be active levels.

The 2-1st transistor T2-1 and the 2-2nd transistor T2-2 may be turned on in response to the first scan signal GWi. For example, the 2-1st transistor T2-1 and the 2-2nd transistor T2-2 are illustrated in FIG. 8B in bold to indicate they are turned on.

The 1-1st sub-transistor TS1-1 may be turned on in response to the i-th second scan signal GCi. The 1-2nd sub-transistor TS1-2 may be turned on in response to the first scan signal GWi. In other words, the 3-1st transistor T3-1 (see FIG. 5) may be activated during the second period P2.

During the second period P2, the 1-1st transistor T1-1 may operate as a source follower. The 1-1st node N1-1 may be provided with a voltage lower than the data signal Vdatat by the threshold voltage (referred to as “Vtha”) of the 1-1st transistor T1-1. In other words, the 1-1st node N1-1 may be charged to a voltage of “VD1−Vtha”, which is obtained by subtracting the threshold voltage from a first voltage (referred to as “VD1”) of the first color data D1.

The first capacitor C1 may store a difference voltage between the first power source line PL1 and the 1-1st node N1-1.

The 7-1st transistor T7-1 and the 7-2nd transistor T7-2 may be turned on in response to the first scan signal GWi. For example, the 7-1st transistor T7-1 and the 7-2nd transistor T7-2 are illustrated in FIG. 8B in bold to indicate they are turned on. The second initialization voltage AINT may be provided to the first electrode of the first light emitting element LDij through the 7-1st transistor T7-1. The residual current of the first electrode of the first light emitting element LDij may be eliminated. The second initialization voltage AINT may be provided to the second light emitting element LDij+1 through the 7-2nd transistor T7-2. The residual current of the first electrode of the second light emitting element LDij+1 may be eliminated.

Referring to FIGS. 7 and 8C, the third period P3 may occur after the second period P2. In the third period P3, the i-th first scan signal GWi and the (i+1)-th second scan signal GCi+1 may be active levels.

The 2-1st transistor T2-1 and the 2-2nd transistor T2-2 may be turned on in response to the first scan signal GWi. For example, the 2-1st transistor T2-1 and the 2-2nd transistor T2-2 are illustrated in FIG. 8C in bold to indicate they are turned on.

The 2-1st sub-transistor TS2-1 may be turned on in response to the first scan signal GWi. The 2-2nd sub-transistor TS2-2 may be turned on in response to the (i+1)-th second scan signal GCi+1. In other words, the 3-2nd transistor T3-2 (see FIG. 5) may be activated during the third period P3.

During the third period P3, the 1-2nd transistor T1-2 may operate as a source follower. The 1-2nd node N1-2 may be provided with a voltage lower than the data signal Vdatat by the threshold voltage (referred to as “Vthb”) of the 1-2nd transistor T1-2. In other words, the 1-2nd node N1-2 may be charged to a voltage of “VD2−Vthb”, which is obtained by subtracting the threshold voltage from a second voltage (referred to as “VD2”) of the second color data D2.

The second capacitor C2 may store a difference voltage between the first power source line PL1 and the 1-2nd node N1-2.

During the first data write period P2 and the second data write period P3, a part of the activation period of the i-th first scan signal GWi may overlap the activation period of the i-th second scan signal GCi, and the other parts of the activation period of the i-th first scan signal GWi may overlap the activation period of the (i+1)-th second scan signal GCi+1.

According to an embodiment of the present disclosure, the i-th first scan signal GWi, the i-th second scan signal GCi, and the (i+1)-th second scan signal GCi+1 may be applied, and a demux circuit may be omitted by using third transistors T3-1 and T3-2 (see FIG. 5) consisting of a dual transistor. Accordingly, the display device 1000 (see FIG. 2) with a reduced area size of the peripheral area NA (see FIG. 2) may be provided, and the display device 1000 (see FIG. 2) with reduced power consumption may be provided compared to a system that includes the demux circuit driven through a separate circuit.

The 7-1st transistor T7-1 and the 7-2nd transistor T7-2 may be turned on in response to the first scan signal GWi. For example, the 7-1st transistor T7-1 and the 7-2nd transistor T7-2 are illustrated in FIG. 8C in bold to indicate they are turned on. The second initialization voltage AINT may be provided to the first electrode of the first light emitting element LDij through the 7-1st transistor T7-1. The residual current of the first electrode of the first light emitting element LDij may be eliminated. The second initialization voltage AINT may be provided to the second light emitting element LDij+1 through the 7-2nd transistor T7-2. The residual current of the first electrode of the second light emitting element LDij+1 may be eliminated.

According to an embodiment of the present disclosure, the residual current of an anode electrode may be removed before emission operations of the light emitting elements LDij and LDij+1 in the fifth period P4. Defects caused by the residual current of the light emitting elements LDij and LDij+1 may be minimized. Accordingly, the display device 1000 (see FIG. 2) with increased display quality may be provided.

Referring to FIGS. 2, 7 and 8D, the fourth period P4 may occur after the third period P3. In the fourth period P4, the emission control signal EMi may be at an active level.

Each of the 5-1st transistor T5-1, the 5-2nd transistor T5-2, the 6-1st transistor T6-1, and the 6-2nd transistor T6-2 may be turned on in response to the emission control signal EMi. For example, the 5-1st transistor T5-1, the 5-2nd transistor T5-2, the 6-1st transistor T6-1, and the 6-2nd transistor T6-2 are illustrated in FIG. 8C in bold to indicate they are turned on.

As the 5-1st transistor T5-1 and the 6-1st transistor T6-1 are turned on, a first driving current ID1 may flow from the first power source line PL1 via the 5-1st transistor T5-1, the 1-1st transistor T1-1, the 6-1st transistor T6-1, the first light emitting element LDij, and the second power source line PL2.

A voltage corresponding to charges stored in the first capacitor C1 may be provided to the gate electrode of the 1-1st transistor T1-1.

As the 5-2nd transistor T5-2 and the 6-2nd transistor T6-2 are turned on, a second driving current ID2 may flow from the first power source line PL1 through the 5-2nd transistor T5-2, the 1-2nd transistor T1-2, the 6-2nd transistor T6-2, the second light emitting element LDij+1, and the second power source line PL2.

A voltage corresponding to charges stored in the second capacitor C2 may be provided to the gate electrode of the 1-2nd transistor T1-2.

Data signals output from the data driving circuit 200 of the display panel DP are written, and thus the light emitting elements LDij and LDij+1 may emit light. The driving currents Id1 and Id2 may be expressed by the following equations.

$$Id = \frac{1}{2} \cdot μ \cdot Cox \cdot \frac{W}{L} {( Vgs - Vth )}^{2} \qquad [ Equation 3 ]$$

$$Vgs = ( ELVDD - Vdata + Vth ) \qquad [ Equation 4 ]$$

$$Id = \frac{1}{2} \cdot μ \cdot Cox \cdot \frac{W}{L} {( ELVDD - Vdata + Vth - Vth )}^{2} \qquad [ Equation 5 ]$$

$$Id = \frac{1}{2} \cdot μ \cdot Cox \cdot \frac{W}{L} {( ELVDD - Vdata )}^{2} \qquad [ Equation 6 ]$$

In Equation 3, Equation 4, Equation 5, and Equation 6, Id may denote the driving currents ID1 and ID2; ELVDD may denote the first power source ELVDD; Vdata may denote the voltage of each of the pieces of color data D1 and D2; μ may denote electric field mobility; Cox may denote capacitance of a gate insulating film; W/L may denote a width and a length of each of the first transistors T1-1 and T1-2; and Vgs may denote a gate-source voltage of each of the first transistors T1-1 and T1-2. In an embodiment, μ and Cox are constants. Equation 6 may be a summary of Equation 5 obtained by reflecting Equation 4 to Equation 3.

The threshold voltage of the driving transistor may vary depending on the characteristics of the driving transistors. However, according to an embodiment of the present disclosure, the threshold voltage of each of the driving transistors T1-1 and T1-2 should not affect the driving current ID1 and ID2 flowing through the light emitting elements LDij and LDij+1 in the first data write period P2 and the second data write period P3. Referring to Equation 6, the driving currents ID1 and ID2 flowing in the light emitting elements LDij and LDij+1 in the fourth period P4 should not be affected by the threshold voltage of the driving transistor. Regardless of the characteristics of the 1-1st transistor T1-1 and the 1-2nd transistor T1-2, the light emitting elements LDij and LDij+1 may be proportional to the square of the voltage difference between the first power source ELVDD and the pieces of color data D1 and D2, respectively. Accordingly, the luminance of the image IM (see FIG. 1) output from the display panel DP may be maintained uniformly. Accordingly, the display device 1000 with increased display quality may be provided.

In an embodiment, the first driving circuit SD outputs the first scan signal GWi and the second scan signal GCi to the scan lines (GWLi to GWLn, GCLi to GCLn) in response to the scan control signal SCS. The delayed second scan signal GCi+1 may be derived from the second scan signal GCi by introducing a predetermined delay before applying it to the sub-transistor (e.g., TS2-2) of the second charge transfer transistor in the second pixel circuit. In an embodiment, this delay may be implemented using a shift register within the first driving circuit SD or a timing control circuit. These delay mechanisms ensure proper timing coordination between GCi and GCi+1 along the second scan lines (GCLi to GCLi+1).

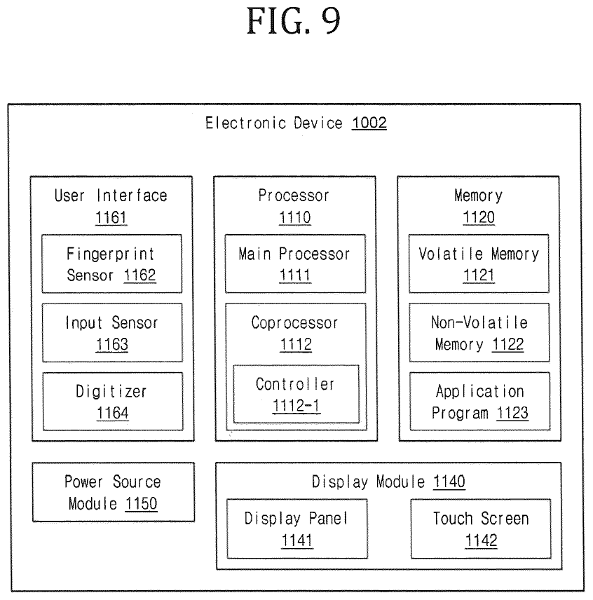

FIG. 9 is a diagram illustrating an electronic device according to an embodiment of the present invention. Referring to FIG. 9, the electronic device 1002 according to one embodiment of the present invention may output various information (e.g., images, text, music, etc.) through a display module 1140, which, for example, may correspond to the display device shown in FIG. 1. When a processor 1110 executes an application stored in a memory 1120, the display module 1140 may provide application information to a user through a display panel 1141.

In some embodiments, the electronic device 1002 may be configured as a smartphone, camera, smart TV, monitor, smartwatch, tablet, automotive display, or AR/VR headset. For example, the electronic device 1002 may be a smartphone including a touch-sensitive display area DA for interaction and a non-display area NDA including sensors and circuits for enhanced functionality. For example, the electronic device 1002 may be a television or monitor including a large display area DA for high-resolution video playback and a non-display area NDA incorporating driving circuits or connectivity modules for external inputs. For example, the electronic device 1002 may be a smartwatch including a display area DA optimized for compact and high-clarity visuals and a non-display area NDA integrating biometric sensors for health monitoring. In some cases, the electronic device 1002 may be an AR/VR headset.

In some embodiments, memory 1120 may store information such as software codes for operating an application program 1123. The application program 1123 may include a software designed to execute specific tasks or provide functionality to a user. The application program 1123 may operate under the control of the processor 1110 and utilizes data stored in the memory 1120 to deliver a wide range of features, such as productivity tools, multimedia streaming and playback, file or mail deliveries or communication services. The application program 1123 interacts seamlessly with the user interface 1161 or touch screen 1142, allowing a user to launch, navigate, and utilize the program through user inputs such as touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module or the camera device. The processor 1110 may transmit image data corresponding to a captured image acquired through the camera module to the display module 1140. The display module 1140 may display an image corresponding to the captured image through the display panel 1141.

For example, the camera device may be configured to capture images of an alignment inspection area of the electronic device, where the alignment inspection area includes an alignment bump (e.g., ABP), an alignment pad (e.g., APD) bonded to the alignment bump, and an alignment polymer pattern (e.g., APP) that is spaced apart from the alignment pad; and the processor 1110 may be configured to: process the captured images to detect center positions of the alignment bump, the alignment pad, and the alignment polymer pattern; compare the detected center positions of the alignment bump and the alignment pad with the center position of the alignment polymer pattern; and determine presence of misalignment based on results of the compare.

As another example, when a user wishes to make a phone call, the user taps the telephone icon displayed on the display module 1140, the processor 1110 may execute a phone application program stored in the memory 1120. A telephone keypad may be presented on the display panel 1141 for the user to enter a phone number to call.

The memory 1120 may store instructions, that, when executed by the processor 1110, cause it to perform the above steps of processing, comparing, and determining misalignment.

As another example, the display module 1140 may be integrated into an electronic device 1002, such as a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs (application program 1123) and various data used by at least one component (for example, the processor 1110 or the user interface 1161) of the electronic device 1002 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The processor 1110 may provide an output signal to the user interface 1161 based on the determination of misalignment, where the output signal can be used to alert operators or activate further inspection or correction processes.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display device shown in FIG. 1.

The user interface 1161 serves as the interaction medium between a user and the electronic device 1002. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as blood pressure, moisture, or body mass.

The input sensor 1163 may sense user interactions including touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1002.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display panel 1141 may include the display unit shown in FIG. 1.

The power source module 1150 may supply power to the components of the electronic device 1002. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the components described above including the display module 1140.

Although embodiments of the present disclosure has been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification.

As described above, according to an embodiment of the present disclosure, a demux circuit may be omitted by using third transistors (e.g., compensation charge transistors), to which a first scan signal, a second scan signal, and a second scan signal delayed by a predetermined time are applied and which are composed of a dual transistor. Accordingly, a display device with a reduced area size of a peripheral area may be provided, and a display device with reduced power consumption may be provided compared to a system that additionally includes a demux circuit driven by a separate circuit.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a first pixel including a first pixel circuit and a first light emitting element;
a second pixel including a second pixel circuit and a second light emitting element; and
a data line configured to receive a data signal,
wherein the first pixel circuit comprises:
a 1-1st transistor including a gate electrode connected to a 1-1st node and connected between a first power source line receiving a first power voltage, and a 2-1st node;
a 2-1st transistor connected to the data line and receiving a first scan signal; and
a 3-1st transistor connected between the 1-1st node and the 2-1st node,
wherein the 3-1st transistor comprises:
a 1-1st sub-transistor receiving a second scan signal; and
a 1-2nd sub-transistor receiving the first scan signal,
wherein the second pixel circuit comprises:
a 1-2nd transistor including a gate electrode connected to a 1-2nd node and electrically connected between a 2-2nd node and the first power source line;
a 2-2nd transistor connected to the data line and receiving the first scan signal; and
a 3-2nd transistor connected between the 1-2nd node and the 2-2nd node,
wherein the 3-2nd transistor comprises:
a 2-1st sub-transistor receiving the first scan signal; and
a 2-2nd sub-transistor receiving the second scan signal that is delayed by a predetermined time.

2. The display device of claim 1, wherein the 1-1st sub-transistor is connected between the 1-1st node and the 1-2nd sub-transistor, and
wherein the 1-2nd sub-transistor is connected between the 2-1st node and the 1-1st sub-transistor.

3. The display device of claim 2, wherein the 2-1st sub-transistor is connected between the 1-2nd node and the 2-2nd sub-transistor, and
wherein the 2-2nd sub-transistor is connected between the 2-2nd node and the 2-1st sub-transistor.

4. The display device of claim 2, wherein the 2-1st sub-transistor is connected between the 2-2nd node and the 2-2nd sub-transistor, and
wherein the 2-2nd sub-transistor is connected between the 1-2nd node and the 2-1st sub-transistor.

5. The display device of claim 1, wherein the 1-1st sub-transistor is connected between the 2-1st node and the 1-2nd sub-transistor, and
wherein the 1-2nd sub-transistor is connected between the 1-1st node and the 1-1st sub-transistor.

6. The display device of claim 5, wherein the 2-1st sub-transistor is connected between the 1-2nd node and the 2-2nd sub-transistor, and
wherein the 2-2nd sub-transistor is connected between the 2-2nd node and the 2-1st sub-transistor.

7. The display device of claim 5, wherein the 2-1st sub-transistor is connected between the 2-2nd node and the 2-2nd sub-transistor, and
wherein the 2-2nd sub-transistor is connected between the 1-2nd node and the 2-1st sub-transistor.

8. The display device of claim 1, wherein the first light emitting element is connected between the 2-1st node and a second power source line receiving a second power voltage having a different voltage level from a voltage level of the first power voltage.

9. The display device of claim 1, wherein when viewed from above a plane, the first light emitting element overlaps the first pixel circuit, and the second light emitting element is positioned in a region offset from the second pixel circuit.

10. The display device of claim 9, wherein the first light emitting element and the second light emitting element emit light of a same color.

11. The display device of claim 9, further comprising:
a first extension wire connected between the first light emitting element and the first pixel circuit; and
a second extension wire connected between the second light emitting element and the second pixel circuit,
wherein a length of the first extension wire is shorter than a length of the second extension wire.

12. The display device of claim 8, wherein the first pixel circuit further comprises:
a 4-1st transistor receiving a third scan signal and connected between the 1-1st node and a first voltage line receiving a first initialization voltage;
a 5-1st transistor receiving an emission control signal and connected between the first power source line and the 1-1st transistor;
a 6-1st transistor receiving the emission control signal and connected between the first light emitting element and the 1-1st transistor; and
a 7-1st transistor receiving the first scan signal and connected between the first light emitting element and a second voltage line receiving a second initialization voltage.

13. The display device of claim 12, wherein the first scan signal is a signal obtained by delaying the third scan signal by a predetermined time.

14. The display device of claim 1, wherein during a first data write period, the first scan signal and the second scan signal are activated to turn on the 3-1st transistor, and
wherein during the first data write period, the 1-1st node is at a voltage obtained by subtracting a threshold voltage of the 1-1st transistor from a first voltage of the data signal.

15. The display device of claim 14, wherein during a second data write period different from the first data write period, the first scan signal and the second scan signal delayed by the predetermined time are activated to turn on the 3-2nd transistor, and
wherein during the second data write period, the 1-2nd node is at a voltage obtained by subtracting a threshold voltage of the 1-2nd transistor from a second voltage of the data signal.

16. The display device of claim 15, wherein a part of an activation period of the first scan signal overlaps an activation period of the second scan signal, and
wherein other parts of the activation period of the first scan signal overlaps the activation period of the second scan signal, which is delayed by the predetermined time.

17. A display device comprising:
a first pixel;
a second pixel; and
a data line connected to the first pixel and the second pixel,
wherein the first pixel includes a first pixel circuit and a first light emitting element connected to the first pixel circuit,
wherein the first pixel circuit comprises:
a 1-1st transistor including a gate electrode connected to a 1-1st node, a first electrode electrically connected to a first power source line receiving a first power voltage, and a second electrode connected to a 2-1st node;
a 2-1st transistor including a gate electrode receiving a first scan signal, a first electrode connected to the data line, and a second electrode; and
a 3-1st transistor connected between the 1-1st node and the 2-1st node, wherein the 3-1st transistor comprises:
a 1-1st sub-transistor including a gate electrode receiving a second scan signal; and
a 1-2nd sub-transistor including a gate electrode receiving the first scan signal,
wherein the second pixel includes a second pixel circuit and a second light emitting element connected to the second pixel circuit,
wherein the second pixel circuit comprises:
a 1-2nd transistor including a gate electrode connected to a 1-2nd node, a first electrode electrically connected to the first power source line, and a second electrode connected to a 2-2nd node;
a 2-2nd transistor including a gate electrode receiving the first scan signal, a first electrode connected to the data line, and a second electrode; and
a 3-2nd transistor connected between the 1-2nd node and the 2-2nd node, and
wherein the 3-2nd transistor comprises:
a 2-1st sub-transistor including a gate electrode receiving the first scan signal; and
a 2-2nd sub-transistor including a gate electrode receiving the second scan signal that is delayed by a predetermined time.

18. The display device of claim 17, wherein the 1-1st sub-transistor is connected between the 1-1st node and the 1-2nd sub-transistor, and
wherein the 1-2nd sub-transistor is connected between the 2-1st node and the 1-1st sub-transistor.

19. The display device of claim 18, wherein the 2-1st sub-transistor is connected between the 1-2nd node and the 2-2nd sub-transistor, and
wherein the 2-2nd sub-transistor is connected between the 2-2nd node and the 2-1st sub-transistor.

20. An electronic device comprising:
a display panel comprising:
a first pixel comprising a first pixel circuit and a first light-emitting element;
a second pixel comprising a second pixel circuit and a second light-emitting element;
a scan driver configured to provide a first scan signal and a second scan signal,
wherein the first pixel circuit comprises:
a first driving transistor including a gate electrode connected to a first node and connected between a first power source line and a second node;
a first switch transistor connected to a data line and configured to receive the first scan signal; and
a first charge transfer transistor connected between the first node and the second node and configured to receive the first scan signal and the second scan signal,
wherein the second pixel circuit comprises:
a second driving transistor including a gate electrode connected to a third node and connected between a fourth node and the first power source line;
a second switch transistor connected to the data line and configured to receive the first scan signal; and
a second charge transfer transistor connected between the third node and the fourth node and configured to receive the first scan signal and the second scan signal that is delayed by a predetermined time.
